(19) United States
(12) Patent Application Publication
(10) Pub. No.: US 2014/0344203 A1
(43) Pub. Date: Nov. 20, 2014

(54) NEURAL NETWORK COMPUTING APPARATUS AND SYSTEM, AND METHOD THEREFOR

(71) Applicant: Byungik Ahn, Seoul (KR)

(72) Inventor: Byungik Ahn, Seoul (KR)

(21) Appl. No.: 14/376,380

(22) PCT Filed: Apr. 20, 2012
(86) PCT No.: PCT/KR2012/003067

§ 371 Date: Aug. 1, 2014

(30) Foreign Application Priority Data
Feb. 3, 2012 (KR) 10-2012-0011256

(51) Int. Cl. G06N 3/08

(52) U.S. Cl. CPC G06N 3/08
USPC 706/25

(57) ABSTRACT

In order to provide a neural network computing apparatus and system, as well as a method therefor, which operate via a synchronization circuit in which all components are synchronized with one system clock, and which include a dispersion-type memory structure for storing artificial neural network data, and a calculating structure for processing all neurons through time-sharing in a pipeline circuit. The neural network computing apparatus includes a control unit for controlling the neural network computing apparatus; a plurality of memory units for outputting both a connection weight value and a neuron state value; and one calculating unit for using the connecting line attribute value and neuron state value inputted from the plurality of memory units so as to calculate a new neuron state value and provide feedback to each of the plurality of memory units.

### CROSS-REFERENCE TO RELATED APPLICATION

This application is a national stage application of PCT/KR2012/003067 filed on Apr. 20, 2012, which claims priority of Korean patent application number 10-2012-0011256 filed on Feb. 3, 2012. The disclosure of each of the foregoing applications is incorporated herein by reference in its entirety.

### TECHNICAL FIELD

Exemplary embodiments of the present invention relate to a digital neural network computing technology; and, more particularly, to a neural, network computing apparatus of which the entire components are operated as a circuit synchronized with one system clock, and which includes a distributed memory structure for storing artificial neural network data and a calculation structure for processing all neurons through a pipeline circuit in a time-division manner, and a method thereof.

### BACKGROUND ART

A digital neural network computer is an electronic circuit which simulates a biological neural network so as to construct a function similar to the role of a brain.

In order to artificially implement a biological neural network, various types of computing methods having a similar structure to the biological neural network have been proposed, and a construction methodology for such a biological neural network may be referred to as a neural network model. In most neural network models, artificial neurons are connected through directional connections so as to form a network. Each of the neurons has a unique state value and transmits the state through the connections, thereby affecting the states of adjacent neurons. Each of the connections between the respective neurons has a unique weight value and serves to adjust the intensity of a signal transmitted therethrough.

Neurons within an artificial neural network may be divided into input neurons to receive an input value from outside, output neurons to transmit a processing result to the outside, and the other hidden neurons.

Unlike a biological neural network, a digital neural network computer cannot linearly change the state value of a neuron. Thus, during a calculation process, the digital neural network computer calculates the state values of the entire neurons one by one and reflects the calculated values at the next calculation. The cycle at which the digital neural network computer calculates the state values of the entire neurons one by one may be referred to as a neural network update cycle. The digital artificial neural network is executed by repeating the neural network update cycles.

In order for the artificial neural network to arrive at a desirable result value, knowledge information within the neural network is stored in the form of connection weights. Steps of accumulating knowledge by adjusting the weights of the connections within the artificial neural network is referred to as a learning mode, and steps of searching for the accumulated knowledge through input data is referred to as a recall mode.

In most neural network models, the recall mode is performed as follows: input data is designated for an input neuron, and the neural network update cycle is repeated to draw the state values of output neurons. Within one neural network update cycle, the state value of each neuron j within the neural network may be calculated as expressed by Equation 1 below.

$${y}_{j} ( T + 1 ) = f ( {\sum }_{i = 1}^{{p}_{j}} {w}_{ij} \cdot {y}_{Mij} ( T ) ) \qquad [ Equation 1 ]$$

Here, yⱼ(T) represents the state value of a neuron j, which is calculated at the T-th neural network update cycle, f represents an activation function for determining a state value of the neuron j, pⱼ represents the number of input connections of the neuron j, wᵢⱼ represents the weight value of the i-th input connection of the neuron j, and Mᵢⱼ represents the number of a neuron connected to the i-th input connection of the neuron j.

In the learning mode, the weights of connections as well as the states of neurons are updated during one neural network update cycle.

The learning model, which is the most generally used for the learning mode is back-propagation algorithm. The back-propagation algorithm is a supervised learning method in which a supervisor outside the system designates the most desirable output value corresponding to a specific input value in the learning mode, and includes the following sub-cycles 1 to 4 within one neural network update cycle:

1. first sub-cycle at which an error value is calculated for each of all output neurons, based on a desirable output value provided from outside and a current output value,

2. second sub-cycle at which an error value of an output neuron is propagated to other neurons such that non-output neurons have an error value, in a backward network where the direction of connections within the neural network correspond to the opposite direction of the original direction,

3. third sub-cycle at which the value of an input neuron is propagated to other neurons so as to calculate new state values of the entire neurons in a forward network where the direction of connections within the neural network corresponds to the original direction (recall mode), and

4. fourth sub-cycle at which the weight value of each of all connections connected to each neuron is adjusted on the basis of the state value of a neuron which is connected to the connection so as to provide a value and the state of a neuron receiving the value.

At this time, the execution order of the four sub-cycles is not important within the neural network update cycle.

At the first sub-cycle, Equation 2 below is calculated for each of all output neurons.

δⱼ(T+1)=teachⱼ−yᵢ(T) [Equation 2]

Here, teachⱼ represents a learning value (training data) provided to an output neuron j, and δⱼ represents an error value of the output neuron j.

At the second sub-cycle, Equation 3 below is calculated for each of all neurons excluding the output neurons.

$${δ}_{j} ( T + 1 ) = {\sum }_{i = 1}^{{p}_{j}^{′}} {w}_{ij}^{′} \cdot {δ}_{Rij} ( T ) \qquad [ Equation 3 ]$$

Here, δⱼ(T) represents an error value of the neuron j at the neural network update cycle T, P′ⱼ represents the number of backward connections of the neuron j in the backward network, w′ᵢⱼ represents the weight value of the i-th connection among the backward connections of the neuron j, and Rij represents the number of a neuron connected to the i-th connection of the neuron j.

At the third sub-cycle, Equation 1 above is calculated for each of all neurons. This is because the third sub-cycle corresponds to the recall mode.

At the fourth sub-cycle, Equation 4 below is calculated for each of all neurons.

$${w}_{ij} ( T + 1 ) = {w}_{ij} ( T ) + η \cdot {δ}_{j} \cdot \frac{d f ( {net}_{j} )}{d {net}_{j}} \cdot {y}_{Mij} \qquad [ Equation 4 ]$$

Here, η represents a constant, and netⱼ represents an input value

$$( \text{?} {w}_{ij} \cdot {δ}_{Mih} ( T ) )$$

$$\text{?} \text{indicates text missing or illegible when filed}$$

of the neuron j.

As for the learning method of the artificial neural network based on the delta learning rule or Hebb's rule, such as the back-propagation algorithm, Equation 4 may be generalized into Equation 5 below.

wᵢⱼ(T+1)=wᵢⱼ(T)+Lⱼ*y_{Mij} [Equation 5]

Here Lj is a unique value of neuron j to be used for learning which may be referred to as a learning attribute.
For reference, Lⱼ in Equation 5 corresponds to

$$η \cdot {δ}_{j} \cdot \frac{d f ( {net}_{j} )}{d {net}_{j}} .$$

The neural network computer may be utilized for searching for a pattern which is the most suitable for a given input or predicting the future based on transcendental knowledge, and used in various fields such as robot control, military equipment, medicine, game, weather information processing, and man-machine interface.

Existing neural network computers are roughly divided into a direct implementation method and a virtual implementation method. According to the direct implementation method, logical neurons of an artificial neural network are mapped one-to-one to physical neurons. Most analog neural network chips belong to the category of the direct implementation method.

The virtual implementation methods compute multiple neurons using a limited number of processing elements in a time-division manner. Most of the virtual implementation methods use an existing Von Neumann computer or use a multi-processor system including such computers connected in parallel, and “ANZA Plus” or “CNAPS” made by “HNC” and “NEP” or “SYNAPSE-1” of “IBM” belong to the category of the virtual implementation method.

### DISCLOSURE

### Technical Problem

The conventional direct implementation method may exhibit high processing speed, but cannot be applied to various neural network models and network topologies, and large-scale neural networks. The conventional virtual implementation method may execute various neural network models and network topologies, and large neural networks, but cannot obtain high processing speed. An object of the present invention is to solve the problems.

An embodiment of the present invention is directed to a neural network computing apparatus and system of which the entire components are operated as a circuit synchronized with one system clock, and which includes a distributed memory structure for storing artificial neural network data and a calculation structure for processing all neurons through a pipeline circuit in a time-division manner, thereby making it possible to apply various neural network models and a large scale network and simultaneously process neurons at high speed, and a method thereof.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with an embodiment of the present invention, a neural network computing apparatus may include: a control unit configured to control the neural network computing apparatus; a plurality of memory units each configured to output a connection weight and a neuron state; and a calculation unit configured to calculate a new neuron state using the connection weights and the neuron states which are inputted from the memory units, and feed back the new neuron state to each of the memory units.

In accordance with an embodiment of the present invention, a neural network computing apparatus may include: a control unit configured to control the neural network computing apparatus; a plurality of memory units each configured to output a connection weight and a neuron state; a calculation unit configured to calculate a new neuron state using the connection weights and the neuron states which are inputted from the memory units; an input unit configured to provide input data from the control unit to an input neuron; a switching unit configured to switch the input data from the input unit or the new neuron state from the calculation unit to the plurality of memory units according to control of the control unit; and first and second output units implemented with a double memory swap circuit that swaps and connects all inputs and outputs according to control of the control unit, and configured to output the new neuron state from the calculation unit to the control unit.

In accordance with an embodiment of the present invention, a neural network computing system may include: a control unit configured to control the neural network computing system; a plurality of memory units each including a plurality of memory parts configured to output connection weights and neuron states, respectively; and a plurality of calculation units each configured to calculate a new neuron state using the connection weights and the neuron states which are inputted from the corresponding memory parts within the plurality of memory units, and feed back the new neuron state to the corresponding memory parts.

In accordance with an embodiment of the present invention, a neural network computing apparatus may include: a control unit configured to control the neural network computing apparatus; a plurality of memory units each configured to output a connection weight and a neuron error value; and a calculation unit configured to calculate a new neuron error value using the connection weights and the neuron error values which are inputted from the memory units, and feed back the new neuron error value to each of the memory units.

In accordance with an embodiment of the present invention, a neural network computing apparatus may include: a control unit configured to control the neural network computing apparatus; a plurality of memory units each configured to output a connection weight and a neuron state and calculate a new connection weight using the connection weight, the neuron state, and a learning attribute; and a calculation unit configured to calculate a new neuron state and the learning attribute using the connection weights and the neuron states which are inputted from the memory units.

In accordance with an embodiment of the present invention, a neural network computing apparatus may include: a control unit configured to control the neural network computing apparatus; a first learning attribute memory configured to store a learning attribute of a neuron; a plurality of memory units each configured to output a connection weight and a neuron state, and calculate a new connection weight using the connection weight, the neuron state, and the learning attribute of the first learning attribute memory; a calculation unit configured to calculate a new neuron state and a new learning attribute using the connection weights and the neuron states which are inputted from the memory units; and a second learning attribute memory configured to store the new learning attribute calculated through the calculation unit.

In accordance with an embodiment of the present invention, a neural network computing apparatus may include: a control unit configured to control, the neural network computing apparatus; a plurality of memory units each configured to store and output a connection weight, a forward neuron state, and a backward neuron error value and calculate a new connection weight; and a calculation unit configured to calculate a new forward neuron state and a new backward neuron error value based on data inputted from each of the memory units, and feed back the new forward neuron state and the new backward neuron error value to each of the memory units.

In accordance with an embodiment of the present invention, there is provided a memory device of a digital system, wherein a double memory swap circuit which swaps and connects all inputs and outputs of two memories using a plurality of digital switches controlled by a control signal from an external control unit is applied to the two memories.

In accordance with an embodiment of the present invention, a neural network computing method may include: outputting, by a plurality of memory units, connection weights and neuron states, respectively, according to control of a control unit; and calculating, by a calculation unit, a new neuron state using the connection weights and the neuron states which are inputted from the memory units and feeding back the new neuron state to each of the memory units, according to control of the control unit. The plurality of memory units and the calculation unit may be synchronized with one system clock and operated in a pipelined manner according to control of the control unit.

In accordance with an embodiment of the present invention, a neural network computing method may include: receiving data, which is to be provided to an input neuron, from a control unit according to control of the control unit; switching the received data or a new neuron state from a calculation unit to a plurality of memory units according to control of the control unit; outputting, by the plurality of memory units, connection weights and neuron states, respectively, according to control of the control unit; calculating, by the calculation unit, a new neuron state using the connection weights and the neuron states which are inputted from the memory units, according to control of the control unit; and outputting, by first and second output units, the new neuron state from the calculation unit to the control unit. The first and second output units may be implemented with a double memory swap circuit which swaps and connects all inputs and outputs according to control of the control unit.

In accordance with an embodiment of the present invention, a neural network computing method may include: outputting, by a plurality of memory parts within a plurality of memory units, connection weights and neuron states, respectively, according to control of a control units; and calculating, by a plurality of calculation units, new neuron states using the connection weights and the neuron states which are inputted from the corresponding memory parts within the plurality of memory units and feeding back the new neuron states to the corresponding memory parts, according to control of the control unit, wherein the plurality of memory parts within the plurality of memory units and the plurality of calculation units are synchronized with one system clock and operated in a pipelined manner according to control of the control unit.

In accordance with an embodiment of the present invention, a neural network computing method may include: outputting, by a plurality of memory units, connection weights and neuron error values, respectively, according to control of a control unit; and calculating, by a calculation unit, a new neuron error value using the connection weights and the neuron error values which are inputted from the memory units and feeding back the new neuron error value to each of the memory units, according to control of the control unit. The plurality of memory units and the calculation unit may be synchronized with one system clock and operated in a pipelined manner according to control of the control unit.

In accordance with an embodiment of the present invention, a neural network computing method may include: outputting, by a plurality of memory units, connection weights and neuron states, respectively, according to control of a control unit; calculating, by a calculation unit, a new neuron state and a learning attribute using the connection weights and the neuron states which are inputted from the memory units, according to control of the control units; and calculating, by the plurality of memory units, new connection weights using the connection weights, the neuron states, and the learning attribute, according to control of the control unit. The plurality of memory units and the calculation unit may be synchronized with one system clock and operated in a pipelined manner according to control of the control unit.

In accordance with an embodiment of the present invention, a neural network computing method may include: storing and outputting, by a plurality of memory units, connection weights, forward neuron states, and backward neuron error values, respectively, and calculating new connection weights, according to control of a control unit; and calculating, by a calculation unit, a new forward neuron state and a new backward neuron error values based on data inputted from each of the memory units and feeding back the new forward neuron state and the new backward neuron error value to each of the memory units, according to control of the control unit. The plurality of memory units and the calculation unit may be synchronized with one system clock and operated in a pipelined manner according to control of the control unit.

### Advantageous Effects

In accordance with the embodiments of the present invention, the neural network computing apparatus and method have no limitation in the network topology of a neural network, the number of neurons, and the number of connections, and may execute various network models including an arbitrary activation function.

Furthermore, the number p of connections which can be simultaneously processed through the neural network computing system may be arbitrarily set and designed, and p connections or less may be simultaneously recalled or trained at each memory access cycle, which makes it possible to increase the processing speed.

Furthermore, while the possible maximum speed is maintained, the precision of operation may be arbitrarily increased.

Furthermore, the neural network computing apparatus may be applied to implement a large-capacity wide-use neural computer, integrated into a small semiconductor device, and applied to various artificial neural network applications.

### DESCRIPTION OF DRAWINGS

FIG. 1 is a configuration diagram of a neural network computing apparatus in accordance with an embodiment of the present invention.

FIG. 2 is a detailed configuration diagram of a control unit in accordance with the embodiment of the present invention.

FIG. 3 is a diagram illustrating a flow of data which are processed through a control signal in accordance with the embodiment of the present invention

FIG. 4 is a diagram for explaining a pipeline structure of the neural network computing apparatus in accordance with the embodiment of the present invention.

FIG. 5 is diagram for explaining a double memory swap method in accordance with the embodiment of the present invention.

FIG. 6 is a detailed configuration diagram of a calculation unit in accordance with the embodiment of the present invention.

FIG. 7 is a diagram for explaining a data flow in the calculation unit in accordance with the embodiment of the present invention.

FIG. 8 is a detailed diagram for explaining a multi-stage pipeline structure of the neural network computing apparatus in accordance with the embodiment of the present invention.

FIG. 9 is a diagram for explaining a parallel array computing method in accordance with the embodiment of the present invention.

FIG. 10 is a diagram illustrating an input/output data flow in the parallel array computing method in accordance with the embodiment of the present invention.

FIG. 11 is a diagram for explaining the structure of a calculation unit in accordance with another embodiment of the present invention.

FIG. 12 is a diagram illustrating an input/output data flow in the calculation unit of FIG. 11.

FIG. 13 is a configuration diagram of a neural network computing system in accordance with an embodiment of the present invention.

FIG. 14 is a diagram for explaining the structure of a neural network computing apparatus which simultaneously performs first and second sub-cycles of a back-propagation learning algorithm in accordance with the embodiment of the present invention.

FIG. 15 is a diagram for explaining the structure of the neural network computing apparatus which executes the learning algorithm in accordance with the embodiment of the present invention.

FIG. 16 is a table illustrating a data flow in the neural network computing apparatus of FIG. 15.

FIG. 17 is a diagram illustrating a neural network computing apparatus which alternately performs a backward propagation cycle and a forward propagation cycle for the entire or partial network of one neural network in accordance with the embodiment of the present invention.

FIG. 18 is a diagram for explaining a calculation structure obtained by simplifying the neural network computing apparatus of FIG. 17.

FIG. 19 is a detailed configuration diagram of a calculation unit of the neural network computing apparatus of FIG. 17 or 18.

FIG. 20 is a diagram for explaining a neural network computing apparatus for executing a learning algorithm in accordance with another embodiment of the present invention.

### BEST MODE

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Moreover, detailed descriptions related to well-known functions or configurations will be ruled out in order not to unnecessarily obscure subject matters of the present invention. Hereafter, exemplary embodiments of the present invention will be described in more detail with reference to the accompanying drawings. Furthermore, the configurations of a device and system in accordance with an embodiment of the present invention will be described with the operations thereof.

Throughout the specification, when an element is referred to as being “connected” to another element, it should be understood that the former can be “directly connected” to the latter, or “electrically connected” to the latter via an intervening element. Furthermore, when an element “comprises” or “includes” another element, the former may not exclude another element, but further comprise or include another element, unless referred to the contrary.

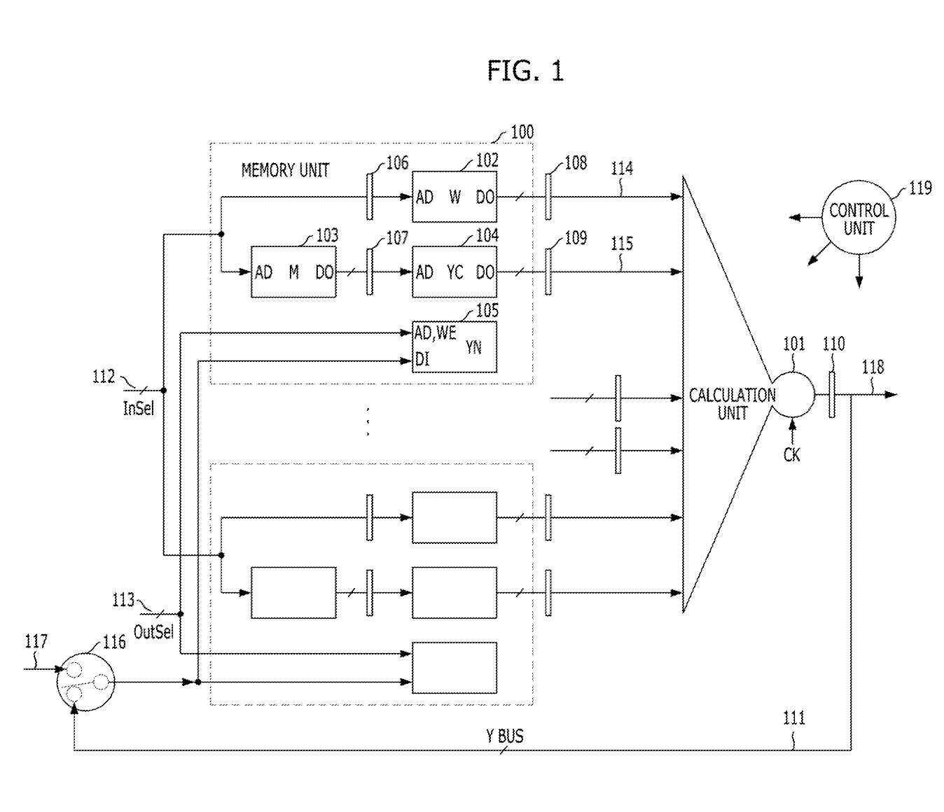

FIG. 1 is a configuration diagram of a neural network computing apparatus in accordance with an embodiment of the present invention, illustrating the basic structure of the neural network computing apparatus.

As illustrated in FIG. 1, the neural network computing apparatus in accordance with the embodiment of the present invention includes a control unit 119, a plurality of memory units 100, and a calculation unit 101. The control unit 119 controls the neural network computing apparatus. The plurality of memory units 100 output connection weights and neuron states, respectively. The calculation unit calculates new neuron states, using the connection weights and the neuron states which are inputted from the memory units 100, and feeds back the new neuron states to the memory units 100. The new neuron states are used as neuron states at the next neural network update cycle.

Here, an InSel input 112 and an OutSel input 113, which are connected to the control unit 119, are commonly connected to the plurality of memory units 100. The InSel input indicates a connection bundle number, and the OutSel input indicates the address at which a neuron state of the next neural network update cycle is to be stored and a write enable signal. Outputs 114 and 115 of each of the memory units 100 are connected to an input of the calculation unit 101. The outputs 114 and 115 may include a connection weight and a neuron state. Furthermore, an output of the calculation unit 101 is commonly connected to inputs of the memory units 100 through Y bus 111. The output of the calculation unit 101 may include the neuron state of the next neural network update cycle.

Each of the memory units 100 may include a W memory (first memory) 102, an M memory (second memory) 103, a YC memory (third memory) 104, and a YN memory (fourth memory) 105. The W memory 102 stores connection weights. The M memory 103 stores the reference numbers of neurons. The YC memory 104 stores neuron states. The YN memory 105 stores new neuron states calculated through the calculation unit 101. The reference number of the neuron may indicate an address value of the YC memory, at which the neuron state is stored, and the new neuron state may indicate the neuron state of the next neural network update cycle.

At this time, address inputs AD of the W memory 102 and the M memory 103 are commonly connected to the InSel input 112, and a data output DO of the M memory 103 is connected to an address input of the YC memory 104. Data outputs of the W memory 102 and the YC memory 104 are connected to the input of the calculation unit 101. The OutSel input 113 is connected to an address/write enable (WE) input AD/WE of the YN memory 105, and the Y bus is connected to a data input DI of the YN memory 105.

The address input terminal of the W memory 102 of the memory unit 100 may further include a first register 106 which temporarily stores a connection bundle number inputted to the W memory, and the address input terminal of the YC memory 104 may further include a second register 107 which temporarily stores the unique number of a neuron, outputted from the M memory.

The first and second registers 106 and 107 may be synchronized with one system clock such that the W memory 102, the M memory 103, and the YC memory 104 are operated in a pipelined manner according to the control of the control unit 119.

The neural network computing apparatus in accordance with the embodiment of the present invention may further include a plurality of third registers 108 and 109 between the outputs of the respective memory units 100 and the input of the calculation unit 101. The third registers 108 and 109 may temporarily store a connection weight provided from the W memory and a neuron state provided from the YC memory, respectively. The neural network computing apparatus in accordance with the embodiment of the present invention may further include a fourth register 110 at the output terminal of the calculation unit 101. The fourth register 110 may temporarily store a new neuron state outputted from the calculation unit. The third and fourth registers 108 to 110 may be synchronized with one system clock such that the plurality of memory units 100 and the calculation unit 101 are operated in a pipelined manner according to the control of the control unit 119.

Furthermore, the neural network computing apparatus in accordance with the embodiment of the present invention may further include a digital switch 116 between the output of the calculation unit 101 and the inputs of the plurality of memory units 100. The digital switch 116 may select between a line 117 to which the value of an input neuron is inputted from the control unit 119 and the Y bus 111 from which the new neuron state calculated through the calculation unit 101 is outputted, and connect the selected line or bus to the respective memory units 100. Furthermore, the output 118 of the calculation unit 101 is connected to the control unit 119 so as to transmit a neuron state to the outside.

The initial values of the W memory 102, the M memory 103, and the YC memory 104 of the memory unit 100 are stored by the control unit 119. The control unit 119 may store values in the respective memories within the memory unit 100 according to the following steps a to h:

a. searching for the number Pmax of input connections of the neuron which has the largest number of input connections within the neural network;

b. when the number of the memory units is represented by p, adding “null” connections such that each of all neurons within the neural network has [Pmax/p]*p connections, the null connections having a connection which has no influence on adjacent neurons even though the null connections are connected to any neuron within the neural network, according to the following methods:

(1) adding a null connection having a connection weight which has no influence on the state of neuron even though the null connection is connected to any neuron; and

(2) adding one virtual neuron having a state which has no influence on neuron within the neural network even though the virtual neuron is connected to any neuron, and connecting all null connections to the virtual neuron;

c. assigning consecutive numbers to the neurons;

d. dividing the connections of all the neurons by p connections so as to classify the connections into [Pmax/p] bundles;

e. assigning consecutive numbers k to the respective connection bundles from the first connection bundle of the first neuron to the last connection bundle of the last neuron;

f. storing the weight of the i-th connection of the k-th connection bundle into the k-th address of the W memory 102 of the i-th memory unit among the memory units 100;

g. storing the initial state of the j-th neuron into the j-th address of the YC memory 104 included in each of the memory units; and

h. storing the reference number of a neuron connected to the i-th connection of the k-th connection bundle into the k-th address of the M memory 103 of the i-th memory unit among the memory units, the reference number of the neuron indicating an address value at which the state of the neuron is stored in the YC memory 104 of the i-th memory unit among the memory units.

When the neural network update cycle is started after the initial values are stored in the memories, the control unit 119 provides a connection bundle number to the InSel input, the connection bundle number starting from 1 and increasing by 1 at each system clock cycle. Starting from predetermined system clock cycles after the neural network update period is started, the weight of connection included in a specific connection bundle and the state of a neuron connected to the inputs of the connection are sequentially outputted through the outputs of the respective memory units 100 at each system clock cycle. Then, the above-described process is repeated from the first connection bundle to the last connection bundle of the first neuron, and repeated from the first connection bundle to the last connection bundle of the next neuron. In this case, the process is repeated until the last connection bundle of the last neuron is outputted.

The calculation unit 101 receives outputs of the memory units 100, that is, connection weights and neuron states, and calculates a new neuron state. When each of all the neurons has n connection bundles, data of the connection bundles of each neuron are sequentially inputted to the input of the calculation unit 101 starting from predetermined system clock cycles after the neural network update cycle is started, and a new neuron state is calculated and outputted through the output of the calculation unit 101 at every n system clock cycles.

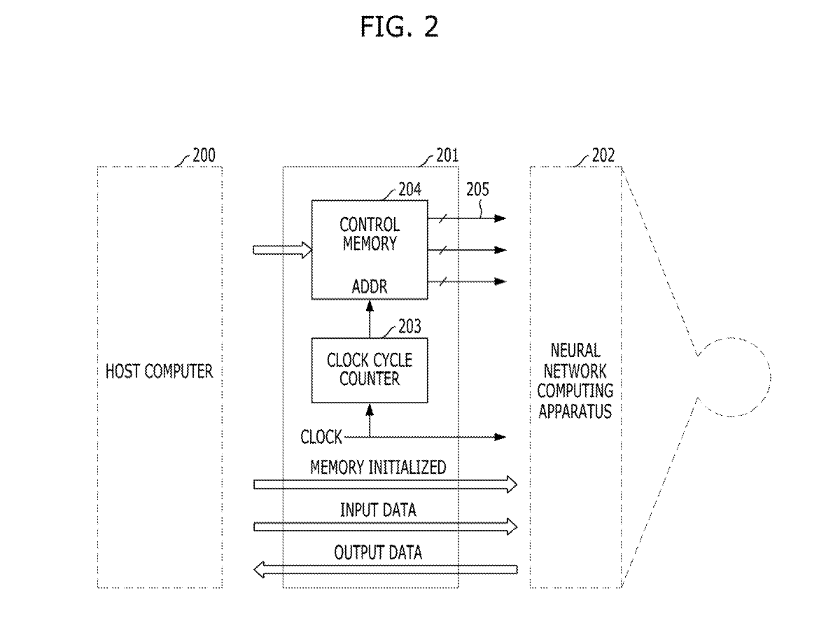

FIG. 2 is a detailed configuration diagram of the control unit in accordance with the embodiment of the present invention.

As illustrated in FIG. 2, the control unit 201 in accordance with the embodiment of the present invention serves to provide various control signals to the neural network computing apparatus 202 described with reference to FIG. 1, initialize the memories included in each of the memory units, load input data in real time or non-real time, or fetch output data in real time or non-real time. Furthermore, the control unit 201 may be connected to a host computer 200 so as to be controlled by a user.

The control memory 204 may store timing and control information of all control signals 205 required for processing connection bundles and neurons one by one within the neural network update cycle. According to a clock cycle within the neural network update cycle, which is provided from a clock cycle counter 203, a control signal may be extracted.

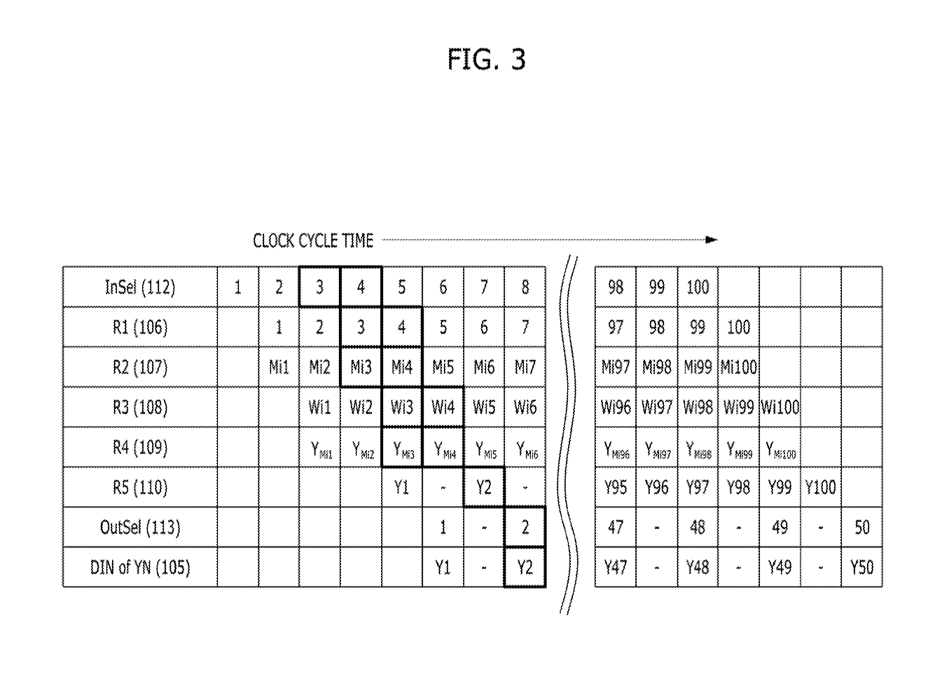

FIG. 3 is a diagram illustrating a flow of data which are processed through a control signal in accordance with the embodiment of the present invention.

In an example illustrated in FIG. 3, suppose that each of all neurons has two connection bundles ([Pmax/p]=2).

When one neural network update cycle is started, the reference numbers of the connection bundles are sequentially inputted through the InSel input 112 by the control unit 201. When a number value k of a specific connection bundle is provided to the InSel input 112 at a specific clock cycle, the number value k and the reference number of a neuron which provides an input to the i-th connection of the k-th connection bundle are stored in the first and second registers 106 and 107, respectively. At the next clock cycle, the weight of the i-th connection of the k-th connection bundle and the state of the neuron which provides an input to the i-th connection of the k-th connection bundle are stored in the third registers 108 and 109, respectively.

Furthermore, p memory units 100 output the weights of p connections belonging to one connection bundle and the states of neurons connected to the respective connections at the same time, and provide the inputs to the calculation unit 101. Then, when the calculation unit 101 calculates a new neuron state after data of two connection bundles of a neuron j are inputted to the calculation unit 101, the new neuron state of the neuron j is stored in the fourth register 110. The new neuron state stored in the fourth register 110 is commonly stored in the YN memories 104 of the respective memory units 100 at the next clock cycle. The new neuron states stored in the respective YN memories are used as neuron states at the next neural network update cycle. At this time, an address at which the new neuron state is to be stored and a write enable signal WE are provided through the OutSel input 113 by the control unit 201. In FIG. 3, boxes indicated by a thick line represent a data flow for calculating a new state of a neuron 2.

When new states of all the neurons within the neural network are calculated and the new state of the last neuron is stored in the YN memory 104, one neural network update cycle may be ended, and the next neural network update cycle may be started.

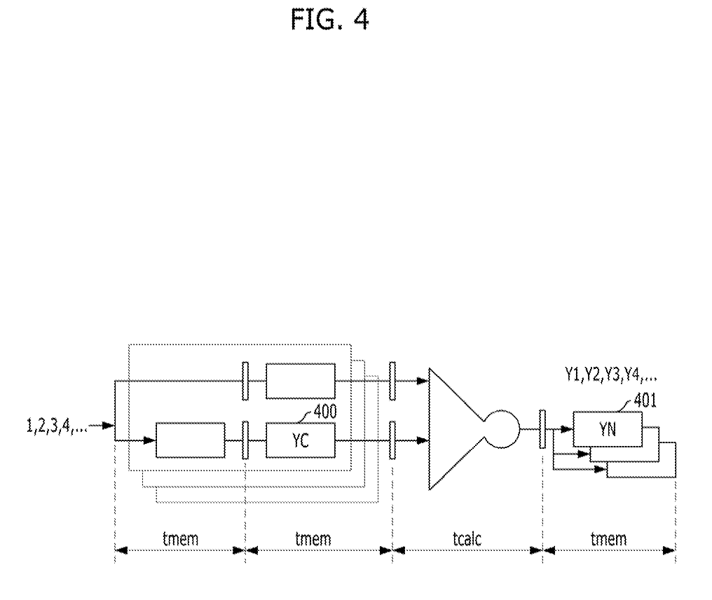

FIG. 4 is a diagram for explaining the pipeline structure of the neural network computing apparatus in accordance with the embodiment of the present invention.

As illustrated in FIG. 4, the neural network computing apparatus in accordance with the embodiment of the present invention operates like a pipelined circuit including multiple pipeline stages according to the control of the control unit. According to the pipeline theory, a clock cycle in the pipelined circuit, that is, a pipeline cycle may be shortened to the time of the stage requiring the longest time among all stages of the pipeline circuit. Thus, when supposing that a memory access time is represented by tmem and throughput of the calculation unit is represented by tcalc, the ideal pipeline cycle of the neural network computing apparatus in accordance with the embodiment of the present invention corresponds to max(tmem, tcalc). When the internal structure of the calculation unit is implemented with a pipelined circuit as described below, the throughput tcalc of the calculation unit may be further improved.

The calculation unit is characterized in that the latency during which output data is calculated after input data is inputted has no significant influence on the performance of the system, especially when there are a number of data to be calculated (the size of the neural network is large). However, the throughput at which the output data is calculated may have significant influence on the performance of the system. Thus, in order to shorten the throughput, the internal structure of the calculation unit may be designed in a pipelined manner.

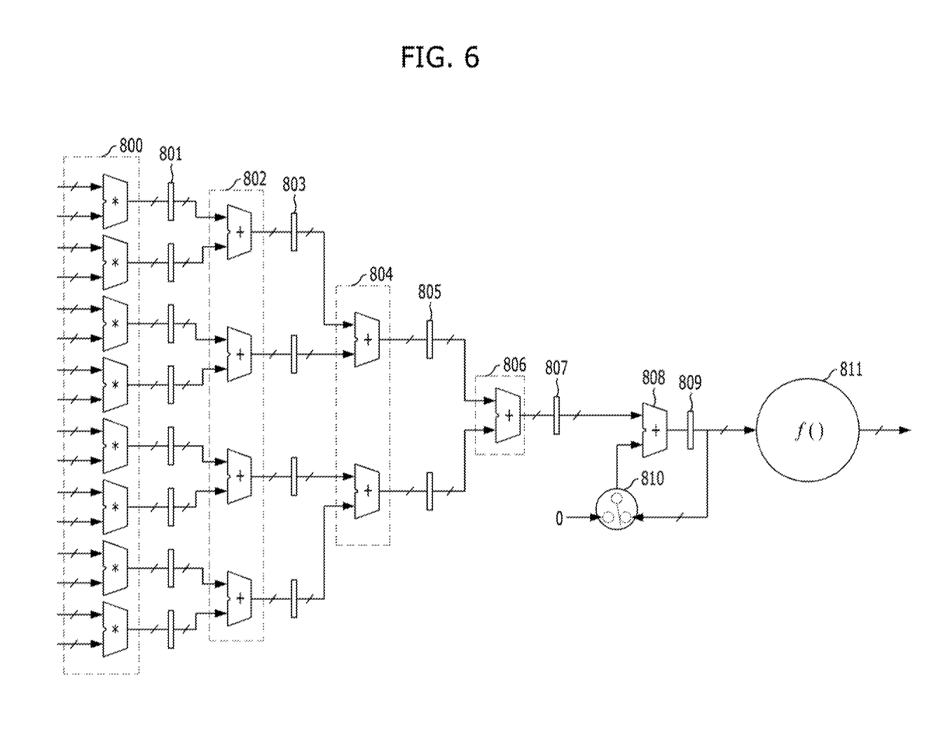

That is, as one method for reducing the throughput of the calculation unit, a register synchronized with a system clock may be added between the respective calculation steps of the calculation unit such that the calculation steps may be processed in a pipelined manner. In this case, the throughput of the calculation unit may be shortened to the maximum throughput among the throughputs of the respective computation steps. This method may be applied regardless of the type of a calculation formula performed through the calculation unit. For example, the method will be more clarified through an embodiment of FIG. 6, which will be described under the precondition of a specific calculation formula.

As another method for reducing the pipeline cycle of the calculation unit, the internal structure of each of all or part of calculation devices belonging to the calculation unit may be implemented with a pipeline circuit synchronized with a system clock. In this case, the throughput of each calculation device may be shortened to the pipeline throughput of the internal structure.

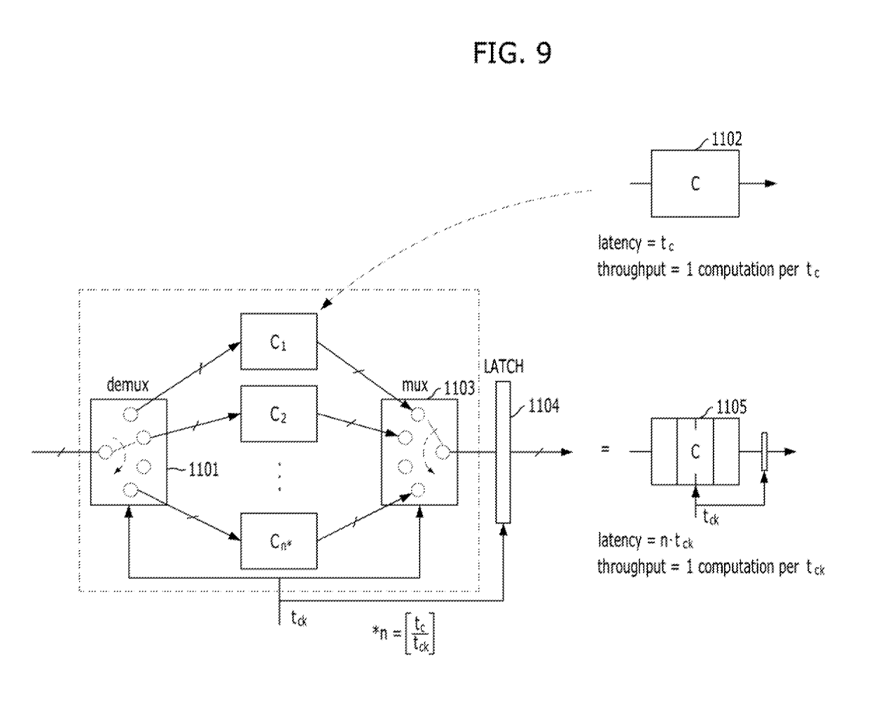

As a method for implementing the internal structure of a specific calculation device within the calculation unit into the pipeline structure, a parallel array computing method may be applied. According to the parallel array computing method, a plurality of demultiplexers corresponding to the number of inputs of the calculation device, the plurality of calculation devices, and a plurality of multiplexers corresponding to the number of outputs of the calculation device are used, input data which are sequentially provided are distributed to the plurality of calculation devices through the demultiplexers, and computation results of the respective calculation devices are collected and added through the multiplexers. This method may be applied regardless of the type of a calculation formula performed through the calculation unit. For example, the method will be more clarified through an embodiment of FIG. 9, which will be described under the precondition of a specific calculation formula.

As described above, a neuron state produced at one neural network update cycle is used as input data at the next neural network update cycle. Thus, when the next neural network update cycle is started after one neural network update cycle is ended, the content of the YN memory 401 needs to be stored in the YC memory 400. However, when the content of the YN memory 401 is copied into the YC memory 400, the processing time may be required to significantly reduce the performance of the system. In order to solve the problem, (1) a double memory swap method, and (2) a single memory duplicate storage method may be used.

First, the double memory swap method may have the same effect as a method in which a plurality of one-bit digital switches are used to completely change and connect inputs and outputs of the same two devices (memories).

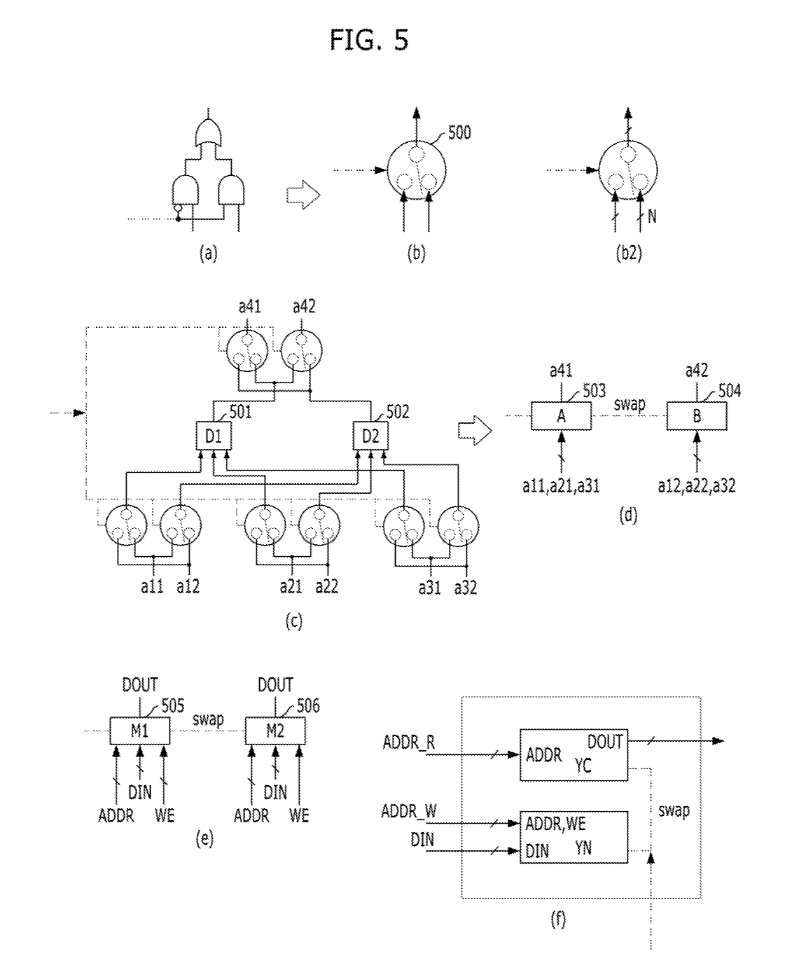

FIG. 5 is diagrams for explaining the double memory swap method in accordance with the embodiment of the present invention.

As one method for implementing a one-bit switch, a logic circuit illustrated in (a) of FIG. 5 may be used. For example, one-bit switch may be represented by 500 in (b) of FIG. 5, and an N-bit switch including N one-bit switches may be represented as illustrated in (b2) of FIG. 5.

A (c) of FIG. 5 illustrates the structure in which two physical devices D1 and D2 having a three-hit input and a one-bit output are implemented with a swap circuit. When all switches are connected to the right position according to a control signal, nodes all, a21, and a31 are connected to the inputs of the physical device D1 501, and a node a41 is connected to the output of the physical device D1 501. Furthermore, nodes a12, a22, and a32 are connected to the inputs of the physical device D2 502, and a node a42 is connected to the output of the physical device D2 502. When all the switches are connected to the left position according to the control signal, the nodes a12, a22, and a32 are connected to the inputs of the physical device D1 501, and the node a42 is connected to the output of the physical device D1 501. Furthermore, the nodes all, a21, and a31 are connected to the inputs of the physical device D2 502, and the node a41 is connected to the output of the physical device D2 502. Then, the roles of the two physical devices 501 and 502 are swapped. As illustrated in (d) of FIG. 5, the swap circuit may be simply expressed by connecting two physical devices 503 and 504 through a dotted line and entering “swap”.

A (e) of FIG. 5 illustrates a double memory swap circuit configured by applying the swap circuit to two memories 505 and 506.

A (f) of FIG. 5 illustrates a circuit which is configured by applying the double memory swap method to the YC memory 104 and the YN memory 105 in FIG. 1 and from which unused inputs and outputs are omitted.

When such a double memory swap method is applied, the roles of the two memories may be swapped according to the control of the control unit, before the next neural network update cycle is started after one neural network update cycle is ended. Thus, the content of the YN memory 105, stored at the previous update cycle, may be directly used in the YC memory 104 without physically transferring the contents of the memories.

The single memory duplicate storage method is a method which uses one memory instead of two memories (for example, the YC memory and the YN memory of FIG. 1), performs a read operation (the role of the YC memory of FIG. 1) and a write operation (the role of the YN memory of FIG. 1) in a time-division manner during one pipeline cycle, and stores neuron state in the same storage place (memory).

FIG. 6 is a detailed configuration diagram of the calculation unit 101 in accordance with the embodiment of the present invention.

When the computation model of the neural network illustrated in FIG. 1 is expressed as Equation 1, the basic structure of the calculation unit 101 may be implemented as illustrated in FIG. 6.

As illustrated in FIG. 6, the calculation unit 101 in accordance with the embodiment of the present invention includes a multiplication unit 800, a plurality of addition units 802, 804, and 806, an accumulator 808, and an activation calculator 811. The multiplication unit 800 includes a plurality of multipliers corresponding to the number of the memory units 100, and performs a multiplication on a neuron state and connection weight provided from the respective memory units 100. The plurality of addition units 802, 804, and 806 are implemented with a tree structure, and perform an addition on a plurality of output values of the multiplication unit 800 through multiple stages. The accumulator 808 accumulates output values of the addition units 802, 804, and 806. The activation calculator 811 applies an activation function to the accumulated output value of the accumulator 808 and calculates a new neuron state which is to be used at the next neural network update cycle.

The calculation unit 101 may further include registers 801, 803, 805, 807, and 809 between the respective computation steps.

That is, the calculation unit 101 in accordance with the embodiment of the present invention further includes a plurality of registers 801 provided between the multiplication unit 800 and the first addition unit 802 of the addition unit tree 802, 804, and 806, a plurality of registers 803 and 805 provided between the respective steps of the addition unit tree 802, 804, and 806, a register 807 provided between the accumulator 808 and the last addition unit 806 of the addition unit tree 802, 804, and 806, and a register 809 provided between the accumulator 808 and the activation calculator 811. The respective registers are synchronized with one system clock, and the respective calculation stages are performed in a pipeline manner.

The operation of the calculation unit 101 in accordance with the embodiment of the present invention will be described in more detail with a specific example. The multiplication unit 800 and the addition units 802, 804, and 806 having a tree structure sequentially calculate the sums of inputs provided through connections included in a series of neural network connection bundles.

The calculator 808 serves to accumulate the sums of inputs of the connection bundles so as to calculate the sum of inputs of a neuron. At this time, when data inputted to the accumulator 808 from the output of the addition unit tree are data of the first connection bundle of a specific neuron, the digital switch 810 is switched to the left terminal by the control unit 201, and the value of 0 is provided to the other input of the accumulator 808 so as to initialize the output of the accumulator 808 to a new value.

The activation calculator 811 serves to apply the activation function to the sum of inputs of the neuron so as to calculate a new neuron state. At this time, the activation calculator 811 may be implemented with a simple structure such as a memory reference table or implemented with a dedicated processor which is executed by microcodes.

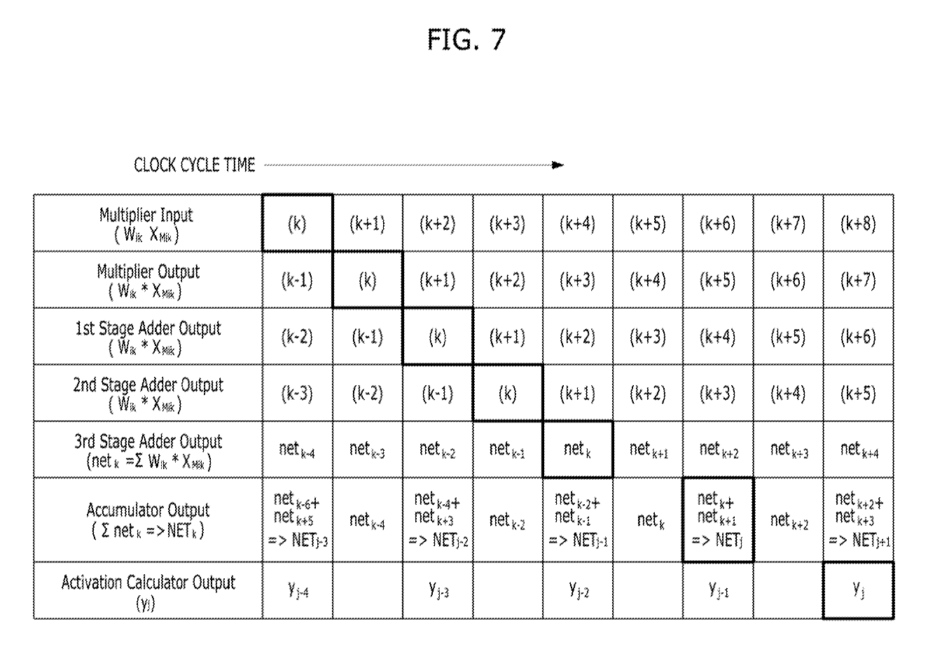

FIG. 7 is a diagram for explaining a data flow in the calculation unit in accordance with the embodiment of the present invention.

As illustrated in FIG. 7, when data of a certain connection bundle k are provided to the input terminal of the multiplication unit 800 at a specific time point, the data of the connection bundle k are processed while progressing step by step. For example, the data of the connection bundle k may appear at the output terminal of the multiplication unit 800 at the next clock cycle, and appear at the output terminal of the first addition unit 802 at the next clock cycle. Finally, when the data arrive at the final addition unit 806, the data may be calculated as a net input of the connection bundle k. The net inputs of the connection bundles are accumulated one by one through the accumulator 808. When the number of connection bundles of one neuron is n, net inputs of the connection bundles are added n times and calculated as a net input of one neuron j. The net input of the neuron j is calculated as a new attribute of the neuron j by the activation function during n clock cycles, and then outputted.

At this time, when the data of the connection bundle k are processed at a specific processing step, data of the connection bundle k−1 are processed at the previous processing step, and data of the connection bundle k+1 are processed at the next processing step.

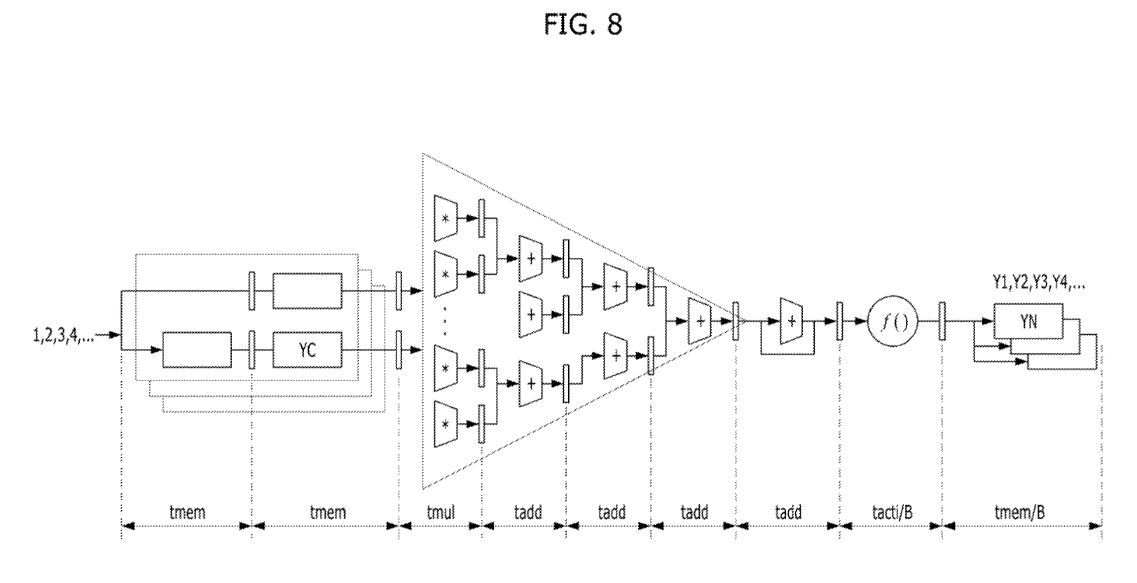

FIG. 8 is a detailed diagram for explaining a multi-stage pipeline structure of the neural network computing apparatus in accordance with the embodiment of the present invention, illustrating a pipeline circuit with a multi-stage structure.

In FIG. 8, tmem represents a memory access time, tmul represents a multiplier processing time, tadd represents an adder processing time, and tacti represents a calculation time of the activation function. In this case, the ideal pipeline cycle is max(tmem, tmul, tadd, tacti/B) where B represents the number of connection bundles for each neuron.

In FIG. 8, each of a multiplier, an adder, and an activation calculator may be implemented with a circuit which is internally executed in a pipelined manner. When supposing that the number of pipeline stages of the multiplier is represented by smul, the number of pipeline stages of the adder is represented by sadd, and the number of pipeline stages of the activation calculator is represented by sacti, the pipeline cycle of the entire system is max(tmem, tmul/smul, tadd/sadd, tacti/(B*sacti)). This means that, when the adder, the multiplier, and the activation calculator can be sufficiently operated in a pipeline manner, the pipeline cycle may be additionally shortened. However, even when the adder, the multiplier, and the activation calculator cannot be operated in a pipeline manner, each of the adder, the multiplier, and the activation calculator may be converted into a pipeline circuit through a plurality of calculation devices. This method which will be described below may be referred to as a parallel array computing method.

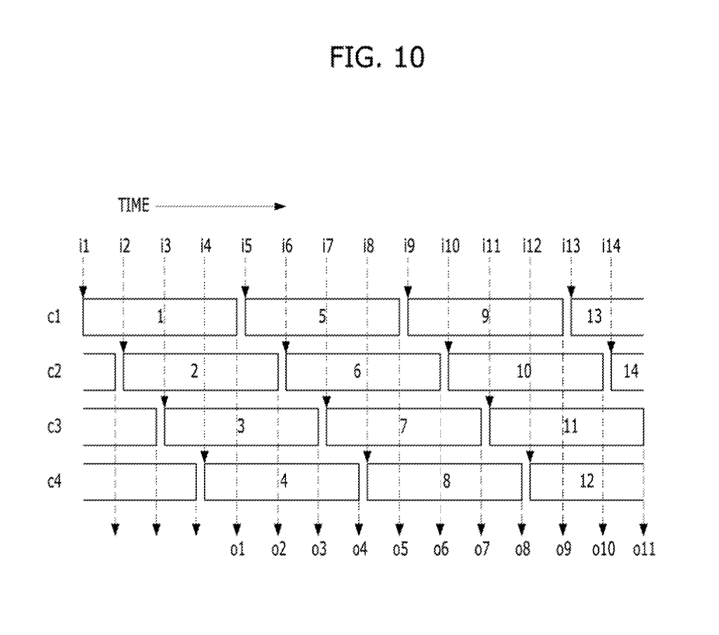

FIG. 9 is a diagram for explaining the parallel array computing method in accordance with the embodiment of the present invention. FIG. 10 is a diagram illustrating an input/output data flow in the parallel array computing method in accordance with the embodiment of the present invention.

When the same computations are executed through a specific device C 1102, a time required for the device C 1102 to process the unit computation may be represented by t_{c}. In this case, a time (latency) required until a result is outputted after input may be represented by t_{c}, and a throughput is one computation per time t_{c}. When the throughput is intended to be increased to one computation per time t_{ck} which is smaller than the time t_{c}, the method illustrated in FIG. 9 may be used.

As illustrated in FIG. 9, one demultiplexer 1101 is used at the input terminal, [t_{c}/t_{ck}] devices C 1102 are used, one multiplexer 1103 is used at the output terminal, and the demultiplexer 1101 and the multiplexer 1103 are synchronized according to a clock t_{ck}. One input data is provided to the input terminal at each clock cycle t_{ck}, and the input data are sequentially demultiplexed to the respective internal devices C 1102. Each of the internal devices C 1102 completes a computation and outputs a result at the time t_{c} after the input data is received, and the multiplexer 1103 selects the output of the device C 1102 completing a computation at each clock t_{ck}, and stores the selected output in a latch 1104.

The demultiplexer 1101 and the multiplexer 1103 may be implemented with a simple logic gate and a decoder circuit, and have no influence on the processing speed. In the embodiment of the present invention, this method is referred to as the parallel array computing method.

The circuit based on the parallel array computing method has the same function as a pipeline circuit 1105 with [t_{c}/t_{ck}] stages, which outputs one result at each clock t_{ck}, and shows a throughput which is increased to one computation per clock t_{ck}. When the parallel array computing method is used, the plurality of devices C 1102 may be used to increase the throughput to a desired level, even though the processing speed of a specific device C 1102 is low. This is the same principle as the number of production lines is raised to increase the output of a manufacturing factory. For example, when the number of devices C is four, an input/output data flow may be formed as illustrated in FIG. 10.

In the aforementioned method in which all neurons have the same number of connection bundles, when the respective neurons have a large difference in number of connections therebetween, the number of null connections may be increased in a neuron having a small number of connection bundles, thereby degrading the efficiency.

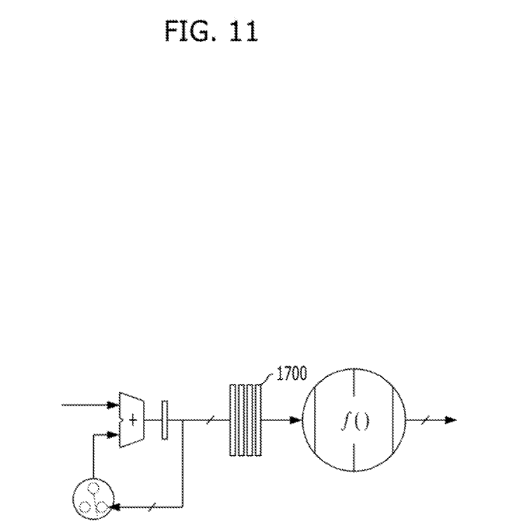

The structure of the calculation unit 101 for solving the problem is illustrated in FIG. 11.

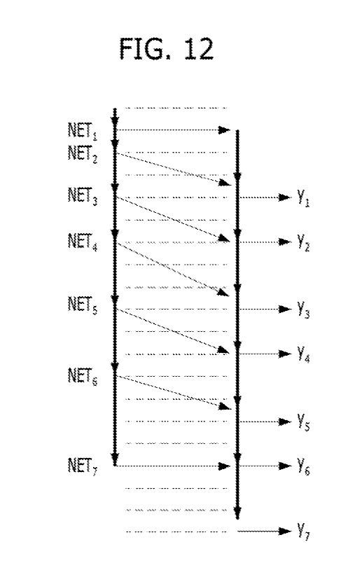

FIG. 11 is a diagram for explaining the structure of a calculation unit in accordance with another embodiment of the present invention. FIG. 12 is a diagram illustrating an input/output data flow in the calculation unit of FIG. 11.

As illustrated in FIG. 11, a FIFO queue 1700 may be provided between the accumulator and the activation calculator described with reference to FIG. 6. At this time, an activation function calculation time may correspond to the average number of connection bundles in the entire neurons, and an input terminal of the activation calculator fetches the least recently stored value in the FIFO queue 1700 at the time at which an input value is required. In this case, the activation calculator may fetch the data accumulated in the FIFO queue 1700 one by one and calculate the fetched data. Thus, the activation calculator may allocate the same calculation time to all the neurons, in order to perform the calculation.

In order for the activation calculator to stably fetch data from the FIFO queue 1700 when the above-described method is used, the control unit may store values in the respective memories of the memory unit 100 of FIG. 1 through the following steps a to g to:

a. sorting all the neurons within the neural network in ascending order based on the number of input connections included in each of the neurons, and sequentially assigning numbers to the respective neurons;

b. when the number of input connections of a neuron j is represented by pj, adding ([pj/p]*p−pj) null connections such that each of the neurons within the neural network has [pj/p]*p connections, where p represents the number of memory units;

c. dividing the connections of all the neurons by p connections so as to classify the connections into connection bundles, and assigning a number i to each of the connections included in each of the connection bundles in arbitrary order, the number i starting from 1 and increasing by 1;

d. sequentially assigning a number k to each of the connection bundles from the first connection bundle of the first neuron to the last connection bundle of the last neuron, the number k starting from 1 and increasing by 1;

e. storing the attribute of the i-th connection of the k-th connection bundle into the k-th address of the W memory unit 102 of the i-th memory unit among the memory units 100;

f. storing the number of a neuron connected to the i-th connection of the k-th connection bundle into the k-th address of the M memory 103 of the i-th memory unit among the memory units 100; and

g. storing the attribute of the j-th neuron into the j-th address of the YC memory 104 of the i-th memory unit among the memory units 100.

Through the above-described method, the connection bundles of the neurons, stored in the memories, are sorted in ascending order based on the number of connections. Thus, as illustrated in FIG. 12, when the activation calculator reads the FIFO queue 1700 at a cycle corresponding to the average number of connection bundles in the entire neurons, data to be processed exist in the FIFO queue 1700 at all times. Therefore, the data may be processed without interruption.

When such a method is used, the activation calculator may periodically process data to improve the efficiency, even though the respective neurons have a great imbalance in number of connections therebetween.

The recall mode of the artificial neural network including inputs and outputs may be executed through the following processes 1 to 3:

1. the value of an input neuron is stored in a Y memory of a memory unit

2. the neural network update cycle is repetitively applied to other neurons excluding the input neuron, and

3. the execution is stopped, and the value of an output neuron is extracted from the Y memory of the memory unit.

In the neural network computing apparatus, the possible maximum processing speed thereof is limited by the memory access cycle tmem. For example, when the number p of connections which can be simultaneously processed by the neural network computing apparatus is set to 1024 and the memory access cycle tmem is set to 10 ns, the maximum processing speed of the neural network computing apparatus is 102.4 GCPS.

As one method for further increasing the maximum processing speed of the neural network computing apparatus,

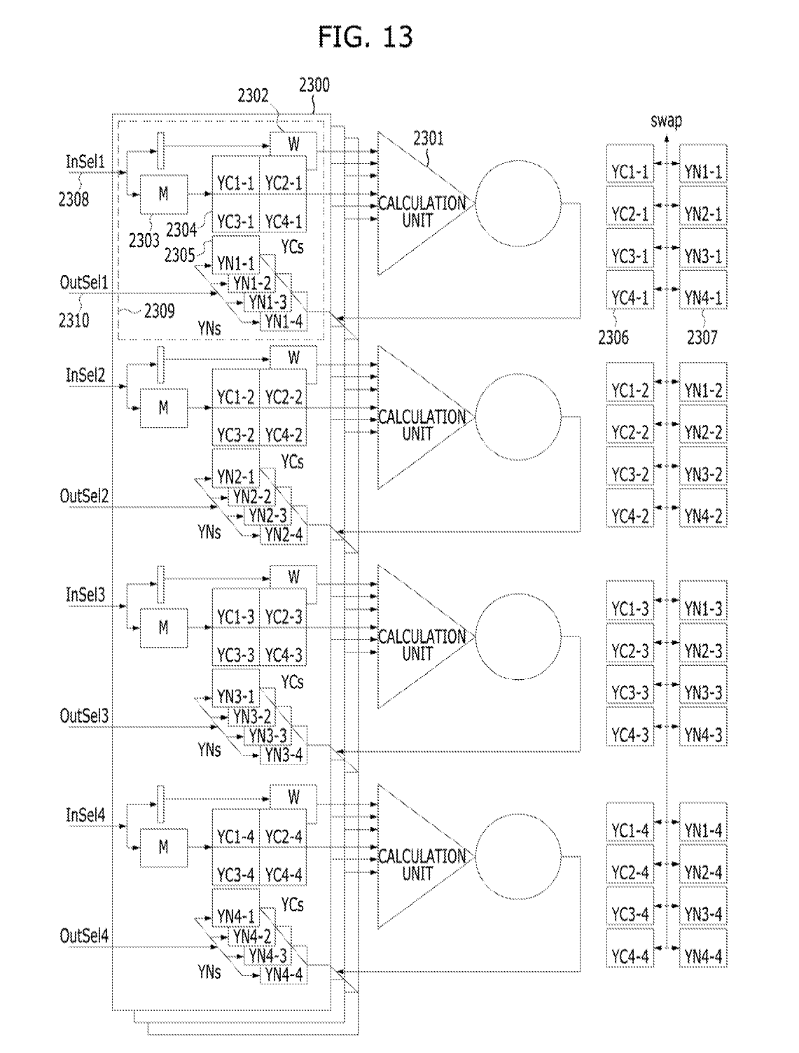

A plurality of neural network computing apparatuses may be coupled into a large-scale synchronized circuit as illustrated in FIG. 13.

FIG. 13 is a configuration diagram of a neural network computing system in accordance with an embodiment of the present invention.

As illustrated in FIG. 13, the neural network computing system in accordance with the embodiment of the present invention includes a control unit (refer to FIG. 2 and the following descriptions), a plurality of memory units 2300, and a plurality of calculation units 2301. The control unit controls the neural network computing system. Each of the memory units 2300 includes a plurality of memory parts 2309 configured to connection weights and neuron states, respectively. Each of the calculation units 2301 calculates new neuron states using the connection weights and the neuron states which are inputted from the corresponding memory parts 2309 within the plurality of memory units 2300, and feeds back the computed attributes to the respective memory parts 2309.

The plurality of memory parts 2309 within the plurality of memory units 2300 and the plurality of calculation units 2301 are synchronized with one system clock and operated in a pipelined manner, according to the control of the control unit.

Each of the memory parts 2309 includes a W memory (first memory) 2302, an M memory (second memory) 2303, a YC memory group (first memory group) 2304, a YC memory group (first memory group) 2304, and a YN memory group (second memory group) 2305. The W memory 2302 stores a connection weights. The M memory 2303 stores the reference numbers of neurons. The YC memory group 2304 stores neuron states. The YN memory group 2305 stores new neuron states calculated through the corresponding calculation unit 2301.

When H neural network computing apparatuses described with reference to FIG. 1 are coupled into one integrated system, the i-th memory unit of the h-th neural network computing apparatus before the coupling becomes the h-th memory part of the i-th memory unit in the neural network computing system. Thus, one memory unit 2300 in the neural network computing system includes H memory parts. One memory part basically has the same structure as the memory unit illustrated in FIG. 1, but has the following differences 1 and 2:

1. h-th of H YC memories in each memory unit is a memory group composed of H unit-YC memories (YC1-h−YCH-h) combined with a memory decoder circuit. Therefore, each YC memory group has a capacity H times larger than the unit-YC memory, and

2. h-th of H YN memories in each memory unit is a memory group composed of H unit-YN memories (YNh-1−YNh-H). All inputs of all unit-YN memories in all h-th YN memories in all memory units are connected together being h-th input of each memory unit.

The neural network computing system implemented with H neural network computing apparatuses includes H calculation units 2301, and the output of h-th calculation unit is connected to the h-th input of each memory unit. The control unit may store values in memories of each memory part within the memory unit 2300 according to the following steps a to h:

a. dividing all neurons within the neural network into H uniform neuron groups;

b. finding the number Pmax of input connections of the neuron which has the largest number of input connections among the neuron groups;

c. when the number of memory units is represented by p, adding null connections such that each of the neurons within the neural network has [Pmax/p]*p connections;

d. numbering all the neurons within each of the neuron groups in arbitrary order;

e. dividing the connections of all the neurons within each of the neuron groups by p connections so as to classify the connections into [Pmax/p] connection bundles, and assigning a number i to each of the connections within the connection bundles in arbitrary order, the number i starting from 1 and increasing by 1;

f. sequentially assigning a number k to each of the connection bundles from the first connection bundle of the first neuron to the last connection bundle of the last connection neuron within each of the neuron groups, the number k starting from 1 and increasing by 1;

g. storing the weight of the i-th connection of the k-th connection bundle of the h-th neuron group into the j-th address of the W memory (first memory) 2302 of the h-th memory part of the i-th memory unit among the memory units; and

h. storing the reference number of a neuron connected to the i-th connection of the k-th connection bundle of the h-th neuron group into the j-th address of the M memory (second memory) 2303 of the h-th memory part of the i-th memory unit among the memory units;

i.

When a and b represent arbitrary constants, each of the memories represented by YCa-b within each of the memory units of FIG. 13 and a memory represented by YNa-b may be implemented in the above-described double memory swap method (2306 and 2307). That is, the j-th memory of the YC memory group (first memory group) of the i-th memory part and the i-th memory of the YN memory group (second memory group) of the j-the memory part may be implemented in the double memory swap method which swaps and connects all inputs and outputs according to the control of the control unit, where i and j are arbitrary natural numbers. Aforementioned single memory duplicate storage method may be used instead of the double memory swap method.

When one neural network update cycle is started, the control, unit supplies a connection bundle number value to an InSel input 2308 for each memory part, the connection bundle number value starting from 1 and increasing by 1 at each system clock cycle. When predetermined system clock cycles pass after the neural network update cycle is started, the memories 2302 to 2305 of the h-th memory part in the memory unit 2300 sequentially output the weights of connections of connection bundles within the h-th neuron group and the states of neurons connected to the connections. The outputs of the h-th memory part in each of the memory units are inputted to the input of the h-th calculation unit, and form the data of the connection bundles of the h-th neuron group. The above-described process is repeated from the first connection bundle to the last connection bundle of the first neuron within the h-th neuron group, and repeated from the first connection bundle to the last connection bundle of the next neuron. In this way, the process is repeated until the data of the final connection bundle of the last neuron are outputted.

When each neuron of the h-th neuron group has n connection bundles, data of the connection bundles included in each neuron of the h-th neuron group are sequentially inputted to the input of the h-th calculation unit at predetermined system clock cycles after the neural network update cycle is started. In addition, the h-th calculation unit calculates and outputs a new neuron state at every n system clock cycles. The new neuron state of the h-th neuron group, calculated through the h-th calculation unit 2301, is commonly stored in all the YN memories 2305 of the h-th memory part in each of the memory units. At this time, an address at which the new neuron state is to be stored and a write enable signal WE are provided through the OutSel input 2310 for each memory part by the control unit 201.

When one neural network update cycle is ended, the control unit swaps all the YC memories with the corresponding YN memories, and couples the values of the YN memories, which have been separately stored at the previous neural network update cycle, into one large-scale YC memory 2304 at a new neural network update cycle. As a result, the large-scale YC memories 2304 of all the memory parts store the states of all the neurons within the neural network.

In such a neural network computing system, when the number of memory units is represented by p, the number of neural network computing apparatuses is represented by H, and the memory access time is represented by tmem, the maximum processing speed of the neural network computing system corresponds to p*H/tmem CPS. For example, when the number p of connections which are simultaneously processed by one neural network computing system is set to 1,024, the memory access time tmem is set to 10 ns, and the number H of neural, network computing apparatuses is set to 16, the maximum processing speed of the neural network computing system is 1638.5 GCPS.

The above-described configuration of the neural network computing system may infinitely expand the scale of the system without a limit of the neural network topology. Furthermore, the configuration of the neural network computing system may improve the performance in proportion to input resources without communication overhead which occurs in the multi-system.

So far, the system structure for the recall mode has been described. Hereafter, a system structure for supporting the learning mode will be described.

As described above, the neural network update cycle of the back-propagation learning algorithm includes first to fourth sub-cycles. In the present embodiment, a calculation structure for performing only the first and second sub-cycles and a calculation structure for performing only the third and fourth sub-cycles will be separately described, and a method for integrating the two calculation structures into one structure will be described.

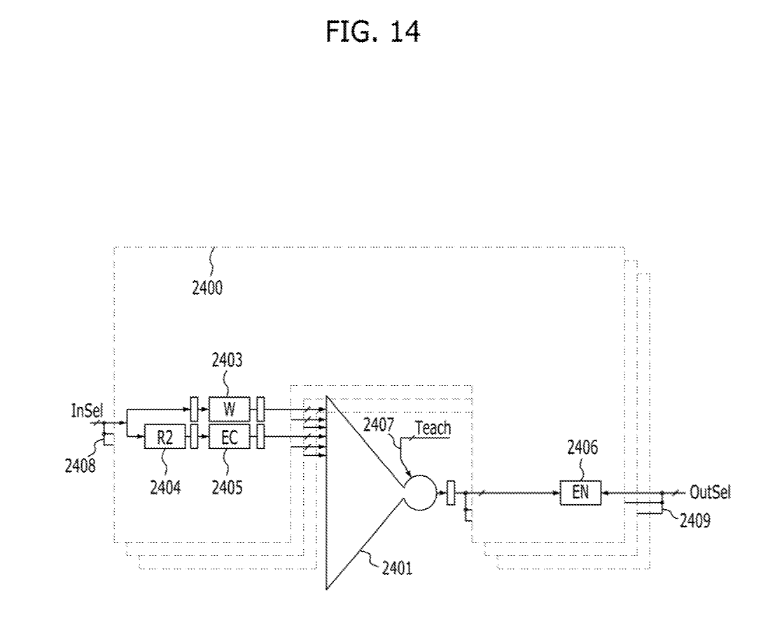

FIG. 14 is a diagram for explaining the structure of a neural network computing apparatus which simultaneously performs the first and second sub-cycles of the back-propagation learning algorithm in accordance with the embodiment of the present invention.

As illustrated in FIG. 14, the neural network computing apparatus which simultaneously performs the first and second sub-cycles of the back-propagation learning algorithm includes a control unit, a plurality of memory units 2400, and a calculation unit 2401. The control unit controls the neural network computing apparatus. The plurality of memory units 2400 output connection weights and neuron error values, respectively. The calculation unit 2401 calculates new neuron error values using the connection weights and the neuron error values which are inputted from the respective memory units 2400 (or using training data provided through the control unit from a supervisor outside the system in addition to the connection weights and the neuron error values), and feeds back the new neuron error values to the respective memory units 2400. The new neuron error values are used as neuron error values at the next neural network update cycle.

At this time, the plurality of memory units 2400 and the calculation unit 2401 are synchronized with one system clock and operated in a pipeline manner, according to the control of the control unit.

An InSel input 2408 and an OutSel input 2409 which are connected to the control unit may be commonly connected to all the memory units 2400. Furthermore, outputs of all the memory units 2400 are connected to an input of the calculation unit 2401, and an output of the calculation unit 2401 is commonly connected to inputs of all the memory units 2400.

Each of the memory units 2400 includes a W memory (first memory) 2403, an R2 memory (second memory) 2404, an EC memory (third memory) 2405, and an EN memory (fourth memory) 2406. The W memory 2403 stores the connection weight. The R2 memory 2404 stores the reference number of a neuron. The EC memory 2405 stores a neuron error value. The EN memory 2406 stores a new neuron error value calculated through the calculation unit 2401.

At this time, the InSel input 2408 is commonly connected to an address input of the W memory 2403 and an address input of the R2 memory within each of the memory units 2400. Furthermore, a data output of the R2 memory 2404 is connected to an address input of the EC memory 2405. Furthermore, a data output of the W memory 2403 and a data output of the EC memory 2405 serve as outputs of the memory unit 2400 and are commonly connected to the input of the calculation unit 2401. Furthermore, the output of the calculation unit 2401 is connected to a data input of the EN memory 2406 of the memory unit 2400, and an address input of the EN memory 2406 is connected to the OutSel input 2409. The EC memory 2405 and the EN memory 2406 may be implemented in the double memory swap method which swaps and connects all inputs and outputs according to the control of the control unit.

The neural network computing apparatus of FIG. 14 has a similar structure to the basic structure of the neural network computing apparatus of FIG. 1, but has the following differences:
instead of the M memory of FIG. 1, the R2 memory 2404 stores the unique number of a neuron connected to a specific connection in a backward network,
instead of the YC memory 104 and the YN memory 105 of FIG. 1, the EC memory 2405 and the EN memory 2406 store an error value of a neuron instead of the state of the neuron,
instead of the step of storing the value of an input neuron in FIG. 1, the calculation unit calculates an error value of an output neuron (being input neuron in the backward network) among the entire neurons by comparing training data of the output neuron, provided through a training data input 2407 of the calculation unit, to the state of the neuron (Equation 2), and
while the calculation unit of FIG. 1 calculates the state of a neuron, the calculation unit of FIG. 24 calculates error values of other neurons excluding the output neuron among the entire neurons, using error values provided through backward connections as factors (Equation).

When the first sub-cycle for calculating error values of output neurons is started within one neural network update cycle, training data of the output neuron are inputted through the training data input 2407 of the calculation unit by the control unit at each clock cycle. When the calculation unit applies Equation 2 to calculate an error value and outputs the error value, the error value is fed back to each of the memory units 2400 and then stored in the EN memory (fourth memory) 2406. This process is repeated until error values of all output neurons are calculated.

When the second sub-cycle for computing error values of other neurons excluding the output neurons is started within one neural network update cycle, the control unit supplies a connection bundle number value to the InSel input, the connection bundle number value starting from 1 and increasing by 1 at each system clock cycle. When predetermined system clock cycles pass after the neural network update cycle is started, the weights of connections of a connection bundle and an error value of a neuron connected to the connections are sequentially outputted through the outputs of the W memory 2403 and the EC memory 2405 of the memory unit 2400. The outputs of the respective memory units 2400 are inputted to the input of the calculation unit 2401, and form data of one connection bundle. The above-described process may be repeated from the first connection bundle to the last connection bundle of the first neuron, and then repeated from the first connection bundle to the last connection bundle of the second neuron. In this way, the process is repeated until the data of the last connection bundle of the last neuron are outputted. The calculation unit 2401 applies Equation 3 to calculates the sums of error values of the respective connection bundles in each neuron, and feeds back the sums to the respective memory units 2400 such that the sums are stored in the EN memories (fourth memories) 2406.

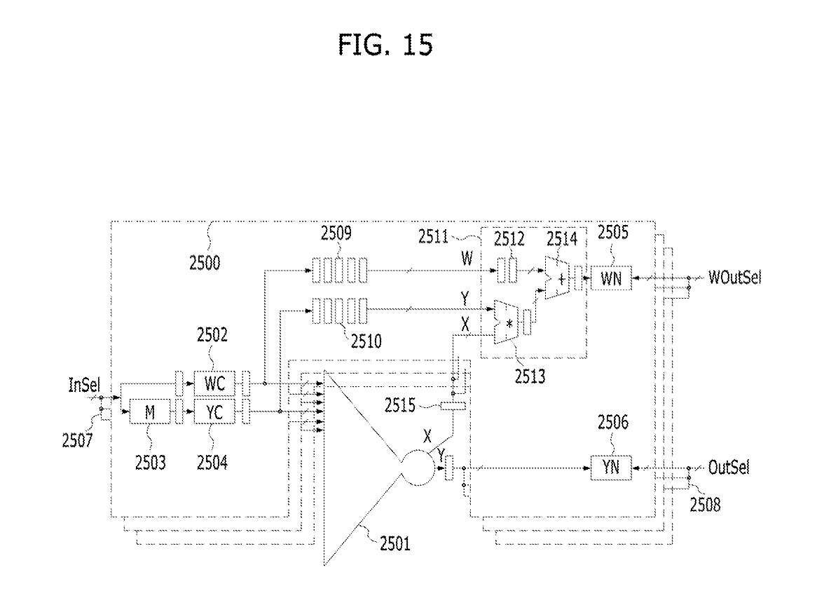

FIG. 15 is a diagram for explaining the structure of the neural network computing apparatus which executes the learning algorithm in accordance with the embodiment of the present invention. This structure may be applied to a neural network model based on the delta learning rule or Hebb's rule.

As illustrated in FIG. 15, the neural network computing apparatus which executes the learning algorithm includes a control unit, a plurality of memory units 2500, and a calculation unit 2501. The control unit controls the neural computing device. Each of the memory units 2500 outputs a connection weight and a neuron state to the calculation unit 250, and calculates a new connection weight using the connection weight, the neuron state, and a learning attribute provided from the calculation unit 2501. The new connection weight is used as a connection weight of the next neural network update cycle. The calculation unit 2501 computes a new neuron state and a learning attribute using the connection weight and the neuron state which are inputted from each of the memory units 2500.

The plurality of memory units 2500 and the calculation unit 2501 are synchronized with one system clock and operated in a pipelined manner, according to the control of the control unit.

Each of the memory units 2500 includes a WC memory (first memory) 2502, an M memory (second memory) 2503, a YC memory (third memory) 2504, a YN memory (fourth memory) 2506, a first FIFO queue (first delay unit) 2509, a second FIFO queue (second delay unit) 2510, a connection weight adjust module 2511, and a WN memory (fifth memory) 2505. The WC memory 2502 stores a connection weight. The M memory 2503 stores the reference number of a neuron. The YC memory 2504 stores a neuron state. The YN memory 2506 stores a new neuron state calculated through the calculation unit 2501. The first FIFO queue 2509 delays the connection weight provided from the WC memory 2502. The second FIFO queue 2510 delays the neuron state provided from the YC memory 2504. The connection weight adjust module 2511 calculates a new connection weight using the learning attribute provided from the calculation unit 2501, the connection weight provided from the first FIFO queue 2509, and the neuron state provided from the second FIFO queue 2510. The WN memory 2505 stores the new connection weight calculated through the connection weight adjust module 2511.

At this time, the first FIFO queue 2509 and the second FIFO queue 2510 serve to delay the weight W of a connection and the state Y of a neuron connected to the connection, and a learning attribute is outputted as an X output of the calculation unit 2501. When a specific connection is one of connections of a neuron j, the weight W of the connection and the state Y of a neuron connected to the connection progress step by step within the respective FIFO queues 2509 and 2510, and are outputted from the respective FIFO queues 2509 and 2510 at the timing at which the X output of the calculation unit 2501, that is, the attribute required for learning of the neuron j is outputted from a register 2515, and then provided to three inputs of the connection weight adjust module 2511. The connection weight adjust module 2511 receives thee three input data W, Y, and X, calculates a new connection weight for the next neural network update cycle, and stores the new connection weight in the WN memory 2505.

Each pair of the YC and YN memories 2504 and 2506 and the WC and WN memories 2502 and 2505 may be implemented in the double memory swap method which swaps and connects all inputs and outputs according to the control of the control unit. As an alternative for this method, the single memory duplicate storage method may be used.

The connection weight adjust module 2511 performs a computation as expressed by Equation 6 below.

Wᵢⱼ(T+1)=f(Wᵢⱼ(T),Yⱼ(T),Lⱼ) [Equation 6]

Here, Wᵢⱼ represents the weight of the i-th connection of a neuron j, Yⱼ represents the state of the neuron j, and Lⱼ represents a learning attribute required for learning of the neuron j.

Equation 6 is a more generalized function including Equation 4. Compared to Equation 4, the weight Wᵢⱼ corresponds to the weight value wᵢⱼ of a connection, the state Yⱼ corresponds to the state value yⱼ of a neuron, and the learning attribute Lⱼ corresponds to

$$η \cdot {δ}_{j} \cdot \frac{d f ( {net}_{j} )}{d {net}_{j}} .$$

The calculation formula is expressed as Equation 7 below.

Wᵢⱼ(T+1)=Wᵢⱼ(T)+Yⱼ(T)*Lⱼ [Equation 7]

The structure of the connection weight adjust module 2511 for calculating Equation 7 may be implemented with one multiplier 2513, a FIFO queue 2512, and one adder 2514. That is, the connection weight adjust module 2511 includes a third FIFO queue (third delay unit) 2512 for delaying a connection weight provided from the first FIFO queue 2509, a multiplier 2513 for multiplying a learning attribute provided from the calculation unit 2501 by a neuron state provided from the second FIFO queue 2510, and an adder 2514 for adding a connection weight provided from the third FIFO queue 2512 and an output value of the multiplier 2513 and outputting a new connection weight. The FIFO queue 2512 serves to delay the attribute Wᵢⱼ(T) while the multiplier 2513 performs the multiplication.

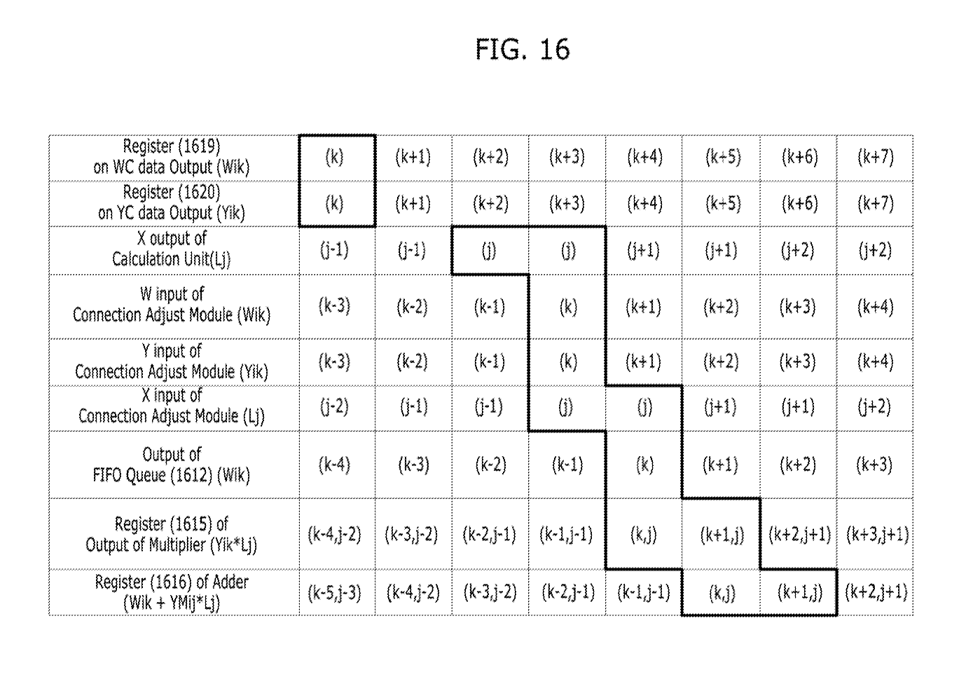

FIG. 16 is a table illustrating a data flow in the neural network computing apparatus of FIG. 15.

FIG. 16 assumes that the number of connection bundles per neuron is set to 2, and the pipeline step of each of the calculation unit, the multiplier, and the adder is set to 1. Furthermore, a connection bundle k is assumed to be the first connection bundle of a neuron j.

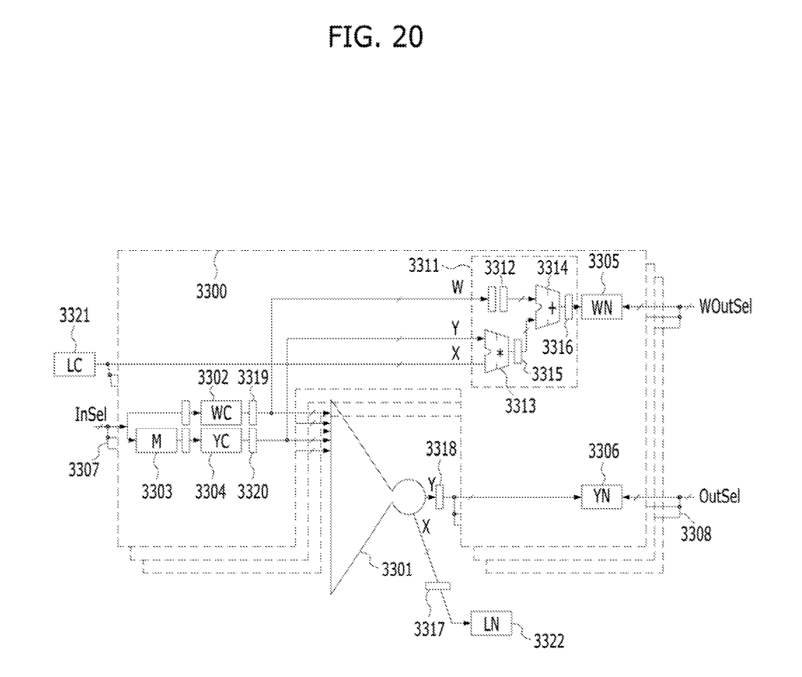

As an alternative for the neural network computing apparatus illustrated in FIG. 15, a neural network computing apparatus illustrated in FIG. 20 may be used.

As illustrated in FIG. 20, the neural network computing apparatus which executes the learning algorithm includes a control unit, a plurality of memory units 3300, a calculation unit 3301, an LC memory (first learning attribute memory) 3321, and an LN memory (second learning attribute memory) 3322. The control unit controls the neural network computing apparatus. Each of the memory units 3300 outputs a connection weight and a neuron state to the calculation unit 3301, and calculates a new connection weight using the connection weight, the neuron state, and a learning attribute. The calculation unit 3301 calculates a new neuron state and a learning attribute using the connection weight and the neuron state which are inputted from each of the memory units 3300. The LC memory 3321 and the LN memory 3322 store the learning attribute.

At this time, the plurality of memory units 3300 and the calculation unit 3301 are synchronized with one system clock and operated in a pipelined manner according to the control of the control unit.

Each of the memory units 3300 includes a WC memory (first memory) 3302, an M memory (second memory) 3303, a YC memory (third memory) 3304, a YN memory (fourth memory) 3306, a connection weight adjust module 3311, and a WN memory (fifth memory) 3305. The WC memory 3302 stores a connection weight. The M memory 3303 stores the reference number of a neuron. The YC memory 3304 stores a neuron state. The YN memory 3306 stores a new neuron state calculated through the calculation unit 3301. The connection weight adjust module 3311 calculates a new connection weight using the connection weight provide from the WC memory 3302, the input neuron state provided from the YC memory 3304, and a learning attribute of the neuron. The WN memory 3305 stores the new connection weight calculated through the connection weight adjust module 3311.

The calculation unit 3301 calculates a new state of a neuron and outputs the new state as Y output. Simultaneously, the calculation unit 3301 calculates a learning attribute required for learning of connections of the neuron and outputs the learning attribute as X output. The X output of the calculation unit 3301 is connected to the LN memory 3322, and the LN memory 3322 serves to store the newly calculated learning attribute Lⱼ(T+1).

The LC memory 3321 stores the learning attribute Lⱼ(T) of the neuron, calculated at the previous neural network update cycle, and a data output of the LC memory 3321 is connected to the X input of the connection weight adjust module 3311 in each of the memory units 3300. An weight output of a specific connection, outputted from the memory unit 3300, and a state output of a neuron connected to the connection are connected to W input and Y input of the connection weight adjust module 3311 within the memory unit 3300. When information of a specific connection is outputted from a memory unit at a specific time point, a learning attribute of a neuron j is simultaneously provided from the LC memory 3321 in case where the connection is one of connections of the neuron j. The connection weight adjust module 3311 receives three input data W, Y, and L, calculates a new connection weight for the next neural network update cycle, and stores the new connection weight in the WN memory 3305.

Each pair of the YC memory 3304 and the YN memory 3306, the WC memory 3302 and the WN memory 3305, and the LC memory 3321 and the LN memory 3322 may be implemented in the double memory swap method which swaps and connects all inputs and outputs according to the control of the control unit. As an alternative for this method, the single memory duplicate storage method may be used.

The connection weight adjust module 3311 may be configured in the same manner as described with reference to FIG. 15. Thus, the descriptions thereof are omitted herein.

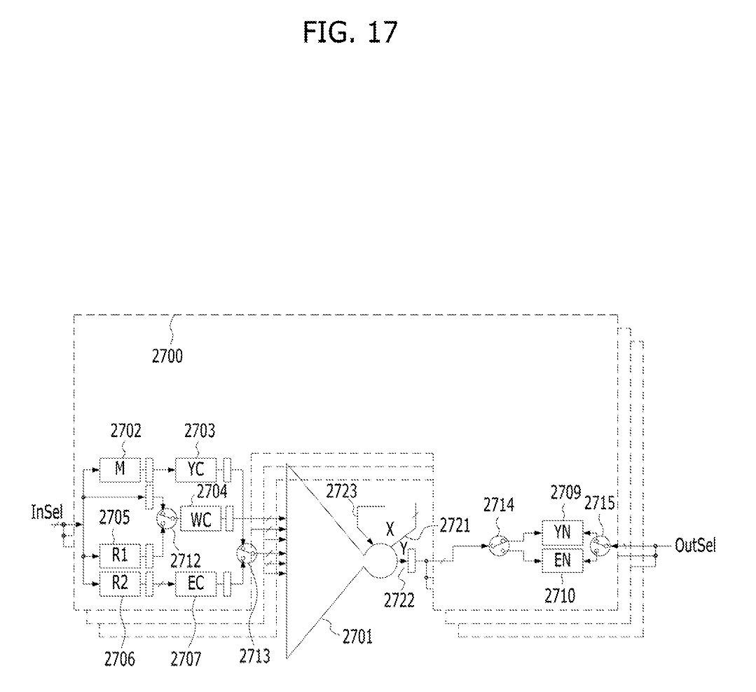

FIG. 17 is a diagram illustrating a neural network computing apparatus which alternately performs a backward propagation cycle and a forward propagation cycle for the entire or partial network of one neural network in accordance with the embodiment of the present invention. The structure in accordance with the embodiment of the present invention may execute the learning mode of a neural network model which alternately performs a backward propagation cycle and a forward propagation cycle for a partial network of the neural network, such as a deep belief network, in addition to the back-propagation learning algorithm. In the case of the back-propagation learning algorithm, the first and second sub-cycles correspond to the backward propagation cycle, and the third and fourth sub-cycles correspond to the forward propagation cycle.

As illustrated in FIG. 17, the neural network computing apparatus which alternately performs a backward propagation cycle and a forward propagation cycle for the entire or partial network of one neural network in accordance with the embodiment of the present invention includes a control unit, a plurality of memory units 2700, and a calculation unit 2701. The control unit controls the neural network computing apparatus. Each of the memory units 2700 stores and outputs a connection weight, a forward neuron state, and a backward neuron error value, and calculates a new connection weight. The calculation unit 2701 calculates a new forward neuron state and a new backward neuron error value based on data inputted from each of the memory units 2700, and feeds back the new forward neuron state and the new backward neuron error value to the corresponding memory unit 2700. In FIG. 17, the circuit for calculating a new connection weight may be easily understood by those skilled in the art, based on the descriptions of FIGS. 15 and 20. Thus, the detailed descriptions thereof are omitted herein.

Each of the memory units 2700 includes an R1 memory (first memory) 2705, a WC memory (second memory) 2704, an R2 memory (third memory) 2706, an EC memory (fourth memory) 2707, an EN memory (fifth memory) 2710, an M memory (sixth memory) 2702, a YC memory (seventh memory) 2703, a YN memory (eighth memory) 2709, a first digital switch 2712, a second digital switch 2713, a third digital switch 2714, and a fourth digital switch 2715. The R1 memory 2705 stores an address value of the WC memory 2704 in the backward network. The WC memory 2704 stores a connection weight. The R2 memory 2706 stores the reference number of a neuron in the backward network. The EC memory 2707 stores a backward neuron error value. The EN memory 2710 stores a new backward neuron error value calculated through the calculation unit 2701. The M memory 2702 stores the reference number of a neuron in the forward network. The YC memory 2703 stores a forward neuron state. The YN memory 2709 stores a new forward neuron state calculated through the calculation unit 2701. The first digital switch 2712 selects an input of the WC memory 2704. The second digital switch 2713 switches an output of the EC memory 2707 or the YC memory 2703 to the calculation unit 2701. The third digital switch 2714 switches an output of the calculation unit 2701 to the EN memory 2710 or the YN memory 2709. The fourth digital switch 2715 switches an OutSel input to the EN memory 2710 or the YN memory 2709.

When the backward propagation cycle (the first and second sub-cycles of the learning mode in the case of the back-propagation learning algorithm) is calculated, each of the N-bit switches 2712 to 2715 within the neural network computing apparatus is positioned at the bottom according to the control of the control unit. In addition, when the forward propagation cycle (the third and fourth sub-cycles of the learning mode in the case of the back-propagation learning algorithm) is calculated, each of the N-bit switches 2712 to 2715 within the neural network computing apparatus is positioned at the top according to the control of the control unit.

Each pair of the YC memory 2703 and the YN memory 2709, the EC memory 2707 and the EN memory 2710, and the WC memory 2704 and the WN memory 2708 may be implemented in the double memory swap method which swaps and connects all inputs and outputs according to control of the control unit. As an alternative for this method, the single memory duplicate storage method may be used.

When one neural network update cycle is started, the control unit controls the N-bit switches 2712 to 2715 to be positioned at the bottom, and performs the backward propagation cycle. Then, the control unit controls the N-bit switches 2712 to 2715 to be positioned at the top, and performs the forward propagation cycle. When the N-bit switches 2712 to 2715 are positioned at the bottom, the system is configured as illustrated in FIG. 14. In this case, however, the InSel input and the WC memory are not directly connected, but connected through the R1 memory. Furthermore, when the N-bit switches 2712 to 2715 are positioned at the top, the available system is configured as illustrated in FIG. 15.

The procedure in which the system operates during the backward propagation cycle may be basically performed in the same manner as described with reference to FIG. 14. However, the content of the WC memory 2704 may be indirectly mapped through the R1 memory 2705 and then selected. This indicates that, although the content of the WC memory 2704 does not coincide with the order of connection bundles in the backward network, the content of the WC memory 2704 may be referred to through the R1 memory 2705 as long as the WC memory 2704 is positioned in the memory unit. The procedure in which the system operates during the forward propagation cycle may be performed in the same manner as described with reference to FIGS. 25 and 33.

The control unit may store values in the respective memories within the memory unit 2700 according to the following steps a to n:

a. when both ends of each connection in the forward network of the artificial neural network are divided into one end from which an arrow is started and the other end at which the arrow is ended, assigning a number to both ends of each connection, the number satisfying the following conditions 1 to 4:

1. outbound connections from each neuron to another neuron have a unique number which does not overlap another number,

2. inbound connections from each neuron to another neuron have a unique number which does not overlap another number,

3. both ends of each connection have the same number, and

4. each connection has as low a number as possible, while satisfying the above-described conditions 1 to 3;

b. searching for the maximum number Pmax among the numbers assigned to the outbound or inbound connections of all the neurons;

c. while the numbers assigned to the respective connections of each neuron within the forward network are maintained, adding new null connections to all empty numbers among the numbers ranging from 1 to [Pmax/p]*p such that each neuron has [Pmax/p]*p input connections;

d. assigning a number to each of all the neurons within the forward network in arbitrary order;

e. dividing the connections of all the neurons within the forward network by p connections so as to classify the connections into [Pmax/p] forward connection bundles, and sequentially assigning a number i to each of the connections within the connection bundles, the number i starting from 1 and increasing by 1;

f. sequentially assigning a number k to each of the forward connection bundles from the first forward connection bundle of the first neuron to the last forward connection bundle of the last neuron, the number k starting from 1 and increasing by 1;

g. storing the initial value of the weight of the i-th connection of the k-th forward connection bundle into the k-th addresses of the WC memory 2704 and the WN memory 2708 of the i-th memory unit among the memory units 2700;

h. storing the reference number of a neuron connected to the i-th connection of the k-th forward connection bundle into the k-th address of the M memory 2702 of the i-th memory unit among the memory units 2700;

i. while the numbers assigned to the respective connections of each neuron within the backward network are maintained, adding new null connections to all empty numbers among the numbers ranging from 1 to [Pmax/p]*p such that each neuron has [Pmax/p]*p input connections;

j. dividing the connections of all the neurons within the backward network by p connections so as to classify the connections into [Pmax/p] backward connection bundles, and sequentially assigning a new number i to each of the connections within the connection bundles, the number i starting from 1 and increasing by 1;

k. sequentially assigning a number k to each of the backward connection bundles from the first backward connection bundle of the first neuron to the last backward connection bundle of the last neuron, the number k starting from 1 and increasing by 1;

l. storing the address of the i-th connection of the k-th backward connection bundle in the WC memory 2704 of the i-th memory unit among the memory units 2700, into the k-th address of the R1 memory 2705 of the i-th memory unit among the memory units 2700;

m. storing the reference number of a neuron connected to the i-th connection of the k-th backward connection bundle into the k-th address of the R2 memory 2706 of the i-th memory unit among the memory units 2700; and

n. storing the backward neuron error value of a neuron j into the j-th addresses of the EC memory 2707 and the EN memory 2710 in each of the memory units.

When the step a is satisfied and a specific connection of the forward network is stored in the i-th memory unit, the same connection is stored in the i-th memory unit of the backward network. Thus, during the backward propagation cycle, the same WC memory 2704 as the WC memory of the forward network may be used and referred to through the R1 memory 2705, even though the storage order thereof does not coincide with the order of the connection bundles in the backward network.

In order to solve the problem of the step a, an edge coloring algorithm may be used, which differently colors edges attached to all nodes in the graph theory. Under the supposition that the numbers of connections connected to each neuron represent different colors, the edge coloring algorithm may be used to solve the problem.

According to the Vizing's theorem and the Konig's bipartite theorem which are from graph theories, when the number of edges of the node which has the largest number of edges among nodes within a graph is set to n, the number of colors required for solving an edge coloring problem in this graph corresponds to n. This means that, when the edge coloring algorithm is applied to the step a so as to designate a connection number, the connection number throughout the entire network does not exceed the number of connections of the neuron having the largest number of connections among the entire neurons.

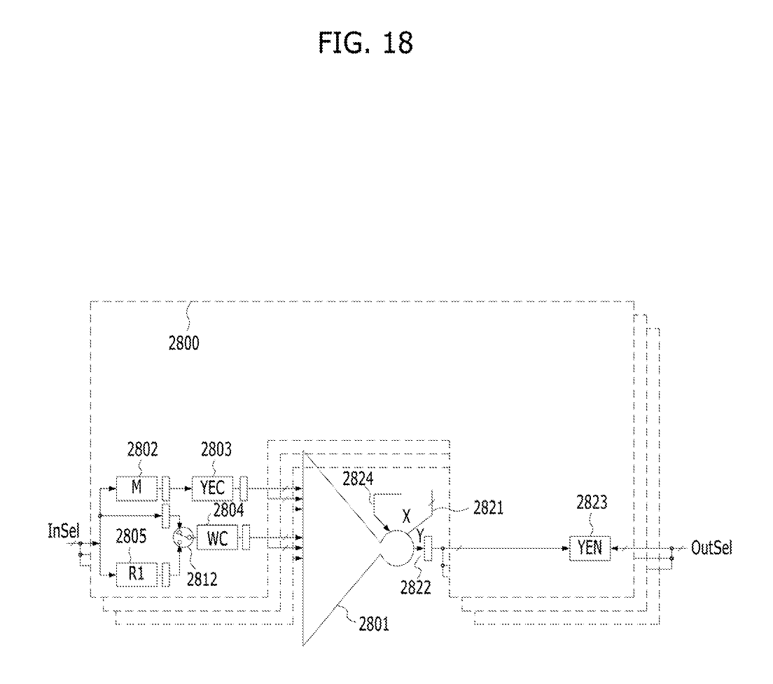

FIG. 18 is a diagram for explaining a calculation structure obtained by simplifying the neural network computing apparatus of FIG. 17.

The M memory 2702, the YC memory 2703, and the YN memory 2709 in FIG. 17 may be divided in such a manner that the halves thereof are used for the use of the R2 memory 2706, the EC memory 2707, and the EN memory 2710, respectively, in order to simplify the neural network computing apparatus as illustrated in FIG. 18.

More specifically, a part of the memory region of an M memory 2802 of FIG. 18 is used for the use of the M memory 2702 of the neural network computing apparatus of FIG. 17, and the other part is used for the use of the R2 memory 270 of the neural network computing apparatus of FIG. 17. Furthermore, a part of the memory region of a YEC 2803 of FIG. 18 is used for the use of the YC memory 2703 of the neural network computing apparatus of FIG. 17, and the other part is used for the use of the EC memory 2707 of the neural network computing apparatus of FIG. 17. Furthermore, a part of the memory region of a YEN memory 2823 of FIG. 18 is used for the use of the YN memory 2709 of the neural network computing apparatus of FIG. 17, and the other part is used for the use of the EN memory 2710 of the neural network computing apparatus of FIG. 17.

As a result, each of the memory units 2800 of FIG. 18 includes an R1 memory (first memory) 2805, a WC memory (second memory) 2804, the M memory 2802 (third memory) 2802, the YEC memory (fourth memory) 2803, the YEN memory (fifth memory) 2823, and a digital switch 2812. The R1 memory 2805 stores an address value of the WC memory 2804. The WC memory 2804 stores a connection weight. The M memory 2802 stores the reference number of a neuron in the forward or backward network. The YEC memory 2803 stores a backward neuron error value or forward neuron state. The YEN memory 2823 stores a new backward neuron error value or forward neuron state which is calculated through the calculation unit 2801. The digital switch 2812 selects an input of the WC memory 2804.

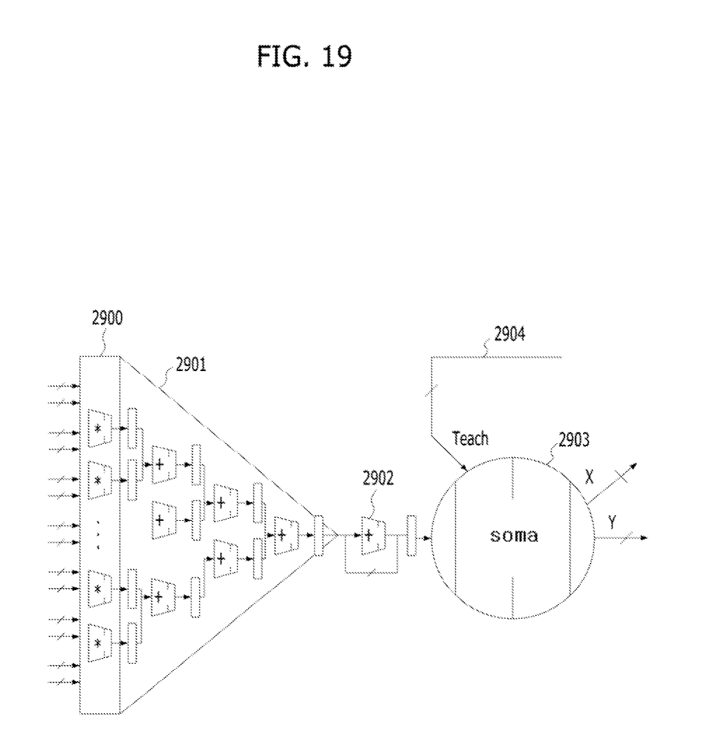

FIG. 19 is a detailed configuration diagram of the calculation unit 2701 or 2801 of the neural network computing apparatus of FIG. 17 or 18.

As illustrated in FIG. 19, the calculation unit 2701 or 2801 includes a multiplication unit 2900, an addition unit 2901, an accumulator 2902, and a soma processor 2903. The multiplication unit 2902 includes a plurality of multipliers corresponding to the number of memory units 2700 and 2800, and performs a multiplication on connection weights from the respective memory units 2700 and 2800 and a forward neuron state or performs a multiplication on the connection weights and a backward neuron error value. The addition unit 2901 has a tree structure, and performs an addition on a plurality of outputs values of the multiplication unit 2900 through multiple stages. The accumulator 2902 accumulates output values from the addition unit 2901. The soma processor 2903 receives leaning data Teach provided through the control unit from a supervisor outside the system and the accumulated output value from the accumulator 2902, and calculates a new forward neuron state or backward neuron error value which will be used at the next neural network update cycle.

The calculation unit 2701 or 2801 in accordance with the embodiment of the present invention may further include registers between the respective calculation steps. In this case, the registers are synchronized with a system clock, and the respective calculation steps are performed in a pipeline manner.

The calculation unit of FIG. 19 has almost the same structure as the above-described calculation unit of FIG. 6, but is different from the calculation unit of FIG. 6 in that the soma processor 2903 is used instead of the activation calculator.

The soma processor 2903 performs the following calculations a to c according to a sub-cycle within the neural network update cycle:

a. in order to calculate an error value of an output neuron at an error calculation sub-cycle when the back-propagation learning algorithm is executed, the soma processor 2903 receives a learning value of each neuron from a training data input 2904, applies Equation 2 to calculate a new error value, stores the new error value therein, and outputs the new error value to Y output. That is, during the cycle at which an error value of an output neuron is calculated, the soma processor 2903 calculates an error value based on a difference between the input training data Teach and the neuron state stored therein, stores the calculated error value therein, and outputs the error value to the Y output. When the back-propagation learning algorithm is not executed, this process may be omitted;

b. in order to calculate error values of other neurons instead of an output neuron at the error calculation sub-cycle when the back-propagation learning algorithm is executed, the soma processor 2903 receives the sum of error inputs from the accumulator 2902, stores the sum of error inputs, and outputs the sum of error inputs to the Y output. When the back-propagation learning algorithm is not executed, the soma processor 2903 performs a calculation according to a backward formula of the corresponding neural network model, and outputs the result to the Y output; and

c. at a neuron state calculation sub-cycle (recall cycle) when the back-propagation learning algorithm is executed, the soma processor 2903 receives a net input value NETk of a neuron from the accumulator 2902, applies an activation function to calculates a new state of the neuron, stores the new state therein, and output the new state to the Y output. Furthermore, the soma processor 2903 calculates a learning attribute

$$Lj = η \cdot {δ}_{j} \cdot \frac{d f ( {sum}_{j} )}{d {sum}_{j}}$$

required for connection weight adjustment, and output the neuron state to the Y output. When the back-propagation learning algorithm is not executed (in recall mode, for example), the soma processor 2903 performs a calculation according to a forward formula of the corresponding neural network model, and outputs the result to the Y output.

In the neural network computing apparatus of FIG. 17 or 18, to which the structure of FIG. is applied as the calculation unit, the entire learning process is performed through the pipeline circuit, and the pipeline cycle is limited only by the memory access time tmem. Since two internal cycles (the first and second sub-cycles or third and fourth sub-cycles) exist within one neural network update cycle in the learning mode, the maximum learning processing speed corresponds to p/(2*tmem) CUPS.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

The present invention may be used for the digital neural network computing system.

1. A neural network computing apparatus comprising:
a control unit configured to control the neural network computing apparatus;
a plurality of memory units each configured to output a connection weight and a neuron state; and
a calculation unit configured to calculate a new neuron state using the connection weight and the neuron state which are inputted from each of the memory units, and feed back the new neuron state to each of the memory units.

2-3. (canceled)

4. The neural network computing apparatus of claim 1, further comprising a switching unit provided between an output of the calculation unit and the plurality of memory units, and configured to select any one of input data from the control unit and the new neuron state from the calculation unit according to control of the control unit, and switch the selected data or neuron state to the plurality of memory units.

5. The neural network computing apparatus of claim 1, wherein each of the memory units comprises:
a first memory configured to store a connection weight;
a second memory configured to store the reference number of a neuron;
a third memory having an address input connected to a data output of the second memory and configured to store a neuron state; and
a fourth memory configured to store the new neuron state calculated through the calculation unit.

6. The neural network computing apparatus of claim 5, wherein each of the memory units further comprises:
a first register operated in synchronization with a system clock, provided at an address input terminal of the first memory, and configured to temporarily store a connection bundle number inputted to the first memory; and
a second register operated in synchronization with the system clock, provided at the address input terminal of the third memory, and configured to temporarily store the reference number of the neuron, outputted from the second memory, and
the first memory, the second memory, and the third memory are operated in a pipeline manner according to the control of the control unit.

7. (canceled)

8. The neural network computing apparatus of claim 5, wherein the control unit stores data in the memories within each of the memory units through the following steps:
a. searching for the number Pmax of input connections of the neuron that has the largest number of input connections within the neural network;
b. when the number of the memory units is represented by p, adding null connections such that each of all neurons within the neural network has [Pmax/p]*p connections, the null connections having a connection weight which has no influence on adjacent neurons even though the null connections are connected to any neuron;
assigning consecutive numbers to the sorted neurons;
d. dividing the connections of all the neurons by p connections so as to classify the connections into [Pmax/p] connection bundles;
e. assigning consecutive numbers k to the respective connection bundles from the first connection bundle of the first neuron to the last connection bundle of the last neuron;
f. storing the weight of the i-th connection of the k-th connection bundle into the k-th address of the first memory of the i-th memory unit;
g. storing the state of the j-th neuron into the j-th addresses of the third memories of the plurality of memory units; and
h. storing the number value of a neuron connected to the i-th connection of the k-th connection bundle into the k-th address of the second memory of the i-th memory unit.

9. (canceled)

10. The neural network computing apparatus of claim 5, wherein the control unit stores data in the memories within each of the memory units through the following steps:
a. searching for the number Pmax of input connections of the neuron that has the largest number of input connections within the neural network;
b. when the number of the memory units is represented by p, adding null connections such that each of all neurons within the neural network has [Pmax/p]*p connections, the null connections having a connection weight which has no influence on adjacent neurons even though the null connections are connected to any neuron;
c. assigning consecutive numbers to the sorted neurons;
d. dividing the connections of all the neurons by p connections so as to classify the connections into [Pmax/p] connection bundles;
e. assigning consecutive numbers k to the respective connection bundles from the first connection bundle of the first neuron to the last connection bundle of the last neuron;
f. storing the weight of the i-th connection of the k-th connection bundle into the k-th address of the first memory of the i-th memory unit;
g. storing the state of the j-th neuron into the j-th addresses of the third memories of the plurality of memory units; and
h. storing the number value of a neuron connected to the i-th connection of the k-th connection bundle into the k-th address of the second memory of the i-th memory unit.

11. The neural network computing apparatus of claim 5, wherein a double memory swap circuit which swaps and connects all inputs and outputs of the same two memories using a plurality of digital switches controlled by a control signal from the control unit is applied to the third and fourth memories.

12. The neural network computing apparatus of claim 1, wherein each of the memory units comprises:
a first memory configured to store a connection weight;
a second memory configured to store the reference number of a neuron; and
a third memory configured to store a neuron state.

13. The neural network computing apparatus of claim 12, wherein an existing neuron state and the new neuron state calculated through the calculation unit are stored in the third memory, and
a single memory duplicate storage circuit which processes a read operation for the existing neuron state and a write operation for the new neuron state calculated through the calculation unit during one pipeline cycle is applied to the third memory.

14-16. (canceled)

17. The neural network computing apparatus of claim 1, wherein a parallel array computing line-method which uses demultiplexers corresponding to the number of inputs of a specific calculation device, a plurality of specific calculation devices, and multiplexers corresponding to the number of outputs of the specific calculation device, demultiplexes input data, which are sequentially provided, to the plurality of specific calculation devices through the demultiplexers, and collects and adds calculation results of the respective specific calculation devices through the multiplexers is applied to implement the internal structures of the respective calculation devices in a pipelined manner.

18. The neural network computing apparatus of claim 1, wherein the calculation unit comprises:
a multiplication unit configured to perform a multiplication on the connection weight and the neuron state from the respective memory units;
an addition unit having a tree structure and configured to perform an addition on a plurality of output values from the multiplication unit through one or more stages;
an accumulator configured to accumulate output values from the addition unit; and
an activation calculator configured to apply an activation function to the accumulated output value from the accumulator and calculate a new neuron state which is to be used at the next neural network update cycle.

19-21. (canceled)

22. The neural network computing apparatus of claim 18, further comprising a FIFO queue provided between the accumulator and the activation calculator.

23-26. (canceled)

27. A neural network computing system comprising:
a control unit configured to control the neural network computing system;
a plurality of memory units each comprising a plurality of memory parts configured to output connection weights and neuron states, respectively; and
a plurality of calculation units each configured to calculate a new neuron state using the connection weights and the neuron states which are inputted from the corresponding memory parts within the plurality of memory units, and feed back the new neuron state to the corresponding memory parts.

28. (canceled)

29. The neural network computing system of claim 27, wherein each of the memory parts comprises:
a first memory configured to store a connection weight;
a second memory configured to store the reference number of a neuron;
a first memory group comprising a plurality of memories to perform the function of an integrated memory having a capacity plural times larger than the unit memory through a decoder circuit, and configured to store neuron states; and
a second memory group comprising a plurality of commonly connected memories and configured to store a new neuron state calculated through the corresponding calculation unit.

30. The neural network computing system of claim 29, wherein the j-th memory of the first memory group of the i-th memory part and the i-th memory of the second memory group of the j-th memory part are implemented in a double memory swap method that swaps and connects all inputs and outputs according to control of the control unit, where i and j are arbitrary natural numbers.

31. The neural network computing system of claim 29, wherein the control unit stores data in the memories within each of the memory parts according to the following steps:
a. dividing all neurons within the neural network into H uniform neuron groups;
b. searching for the number Pmax of input connections of the neuron that has the largest number of input connections within each of the neuron groups;
c. represented by p, adding null connections such that each of all the neurons within the neural network has [Pmax/p]*p connections;
d. numbering all the neurons within each of the neuron groups in arbitrary order;
e. connection bundles;
f. assigning a number k to each of the connection bundles from the first connection bundle of the first neuron to the last connection bundle of the last neuron in each of the neuron groups, the number k starting from 1 and increasing by 1;
g. storing the weight of the i-th connection of the k-th connection bundle of the h-th neuron group into the j-th address of the first memory of the h-th memory part of the i-th memory unit among the memory units; and
h. reference number of a neuron connected to the i-th connection of the k-th connection bundle of the h-th neuron group into the j-th address of the second memory of the h-th memory part of the i-th memory unit among the memory units.

32. (canceled)

33. A neural network computing apparatus comprising:
a control unit configured to control the neural network computing apparatus;
a plurality of memory units each configured to output a connection weight and a neuron error value; and
a calculation unit configured to calculate a new neuron error value using the connection weight and the neuron error value which are inputted from each of the memory units, and feed back the new neuron error value to each of the memory units.

34. The neural network computing apparatus of claim 33, wherein the calculation unit calculates a new neuron error value using the connection weight and the neuron error value which are inputted from each of the memory units and training data provided from the control unit, and feeds back the new neuron error value to each of the memory units.

35. The neural network computing apparatus of claim 33, wherein each of the memory units comprises:
a first memory configured to store a connection weight;
a second memory configured to store the reference number of a neuron;
a third memory configured to store a neuron error value; and
a fourth memory configured to store the new neuron error value calculated through the calculation unit.

36. A neural network computing apparatus comprising:
a control unit configured to control the neural network computing apparatus;
a plurality of memory units each configured to output a connection weight and a neuron state and calculate a new connection weight using the connection weight, the neuron state, and a learning attribute; and
a calculation unit configured to calculate a new neuron state and the learning attribute using the connection weight the neuron state which are inputted from each of the memory units.

37. The neural network computing apparatus of claim 36, wherein each of the memory units comprises:
a first memory configured to store a connection weight;
a second memory configured to store the reference number of a neuron;
a third memory configured to store a neuron state;
a fourth memory configured to store the new neuron state calculated through the calculation unit;
a first delay unit configured to delay the connection weight from the first memory;
a second delay unit configured to delay the neuron state from the third memory,
a connection weight adjust module configured to calculate a new connection weight using the learning attribute from the calculation unit, the connection weight from the first delay unit, and the neuron state from the second delay unit; and
a fifth memory configured to store the new connection weight calculated through the connection weight adjust module.

38. The neural network computing apparatus of claim 37, wherein a double memory swap circuit that swaps and connects all inputs and outputs according to control of the control unit is applied to each pair of the first and fifth memories and the third and fourth memories.

39. The neural network computing apparatus of claim 37, wherein each pair of the first and fifth memories and the third and fourth memories is implemented with one memory.

40. The neural network computing apparatus of claim 37, wherein the connection weight adjust module comprises:
a third delay unit configured to delay the connection weight from the first delay unit;
a multiplier configured to multiply the learning attribute from the calculation unit by the neuron state from the second delay unit; and
an adder configured to add the connection weight from the third delay unit and an output value of the multiplier and output a new connection weight.

41. A neural network computing apparatus comprising:
a control unit configured to control the neural network computing apparatus;
a first learning attribute memory configured to store a learning attribute of a neuron;
a plurality of memory units each configured to output a connection weight and a neuron state, and calculate a new connection at weight using the connection weight, the neuron state, and the learning attribute of the first learning attribute memory;
a calculation unit configured to calculate a new neuron state and a new learning attribute using the connection weight the neuron state which are inputted from each of the memory units; and
a second learning attribute memory configured to store the new learning attribute calculated through the calculation unit.

42. The neural network computing apparatus of claim 41, wherein each of the memory units comprises:
a first memory configured to store a connection weight;
a second memory configured to store the reference number of a neuron;
a third memory configured to store a neuron state;
a fourth memory configured to store a new neuron state calculated through the calculation unit;
a connection weight adjust module configured to calculate a new connection weight using the connection weight, the neuron state, and the learning attribute of the first learning attribute memory; and
a fifth memory configured to store the new connection weight calculated through the connection weight adjust module.

43. The neural network computing apparatus of claim 42, wherein a double memory swap circuit which swaps and connects all inputs and outputs according to control of the control unit is applied to each pair of the first and second learning attribute memories, the first and fifth memories, and the third and fourth memories.

44. The neural network computing apparatus of claim 42, wherein each pair of the first and second learning attribute memories, the first and fifth memories, and the third and fourth memories is implemented with one memory.

45. (canceled)

46. A neural network computing apparatus comprising:
a control unit configured to control the neural network computing apparatus;
a plurality of memory units each configured to store and output a connection weight, a forward neuron state, and a backward neuron error value and calculate a new connection weight; and
a calculation unit configured to calculate a new forward neuron state and a new backward neuron error value based on data inputted from each of the memory units, and feed back the new forward neuron state and the new backward neuron error value to each of the memory units.

47. (canceled)

48. The neural network computing apparatus of claim 46, wherein each of the memory units comprises:
a first memory configured to store an address value of a second memory;
the second memory configured to store a connection weight;
a third memory configured to store the reference number of a neuron;
a fourth memory configured to store a backward neuron error value;
a fifth memory configured to store a new backward neuron error value calculated through the calculation unit;
a sixth memory configured to store the reference number of a neuron;
a seventh memory configured to store a forward neuron state;
an eighth memory configured to store a new forward neuron state calculated through the calculation unit;
a first switch configured to select an input of the second memory;
a second switch configured to switch an output of the fourth or seventh memory to the calculation unit;
a third switch configured to switch an output of the calculation unit to the fifth or eighth memory; and
switch configured to switch an OutSel input to the fifth or eighth memory.

49-50. (canceled)

51. The neural network computing apparatus of claim 48, wherein the control unit stores data in the memories within each of the memory units according to the following steps:
a. when both ends of each connection in a forward network of the artificial neural network are divided into one end from which an arrow is started and the other end at which the arrow is ended, assigning a number satisfying the following conditions to both ends of each connection:
1. outbound connections from each neuron to another neuron have a unique number which does not overlap another number;
2. inbound connections from each neuron to another neuron have a unique number which does not overlap another number,
3. both ends of each connection have the same number, and
4. each connection has as low a number as possible, while satisfying the above-described conditions 1 to 3;
b. searching for the largest number Pmax among the numbers assigned to the outbound or inbound connections of all the neurons;
c. while the numbers assigned to the respective connections of all the neurons within the forward network are maintained, adding new null connections to all empty numbers among numbers ranging from 1 to [Pmax/p]*p such that each neuron has [Pmax/p]*p input connections;
d. assigning numbers to the respective neurons within the forward network in arbitrary order;
e. dividing the connections of all the neurons within the forward network by p connections so as to classify the connections into [Pmax/p] forward connection bundles;
f. sequentially assigning a number k to each of the forward connection bundles from the first forward connection bundle of the first neuron to the last forward connection bundle of the last neuron, the number k starting from 1 and increasing by 1;
g. storing the initial value of the weight of the i-th connection of the k-th forward connection bundle into the k-th addresses of the second and ninth memories of the i-th memory unit among the memory units;
h. storing the unique number of a neuron connected to the i-th connection of the k-th forward connection bundle into the k-th address of the sixth memory of the i-th memory unit among the memory units;
i. storing a forward neuron state of a neuron having a unique number j into the j-th addresses of the seventh and eighth memories of each of the memory units;
j. while the numbers assigned to the respective connections of all the neurons within the backward network are maintained, adding new null connections to all empty numbers among numbers ranging from 1 to [Pmax/p]*p such that each neuron has [Pmax/p]*p input connections;
k. dividing the connections of all the neurons within the backward network by p connections so as to classify the connections into [Pmax/p] backward connection bundles;
l. sequentially assigning a number k to each of the backward connection bundles from the first backward connection bundle of the first neuron to the last backward connection bundle of the last neuron, the number k starting from 1 and increasing by 1;
m. storing the position value of the i-th connection of the k-th backward connection bundle, which is positioned in the second memory of the i-th memory unit among the memory units, into the k-th address of the first memory of the i-th memory unit among the memory units;
n. storing the reference number of a neuron connected to the i-th connection of the k-th backward connection bundle into the k-th address of the third memory of the i-th memory unit among the memory units.

52. The neural network computing apparatus of claim 51, wherein a value satisfying the condition of the step a is acquired through an edge coloring algorithm.

53. The neural network computing apparatus of claim 46, wherein each of the memory units comprises:
a first memory configured to store an address value of a second memory,
the second memory configured to store a connection weight;
a third memory configured to store the reference number of a neuron;
a fourth memory configured to store a backward neuron error value or forward neuron state;
a fifth memory configured to store a new backward neuron error value or forward neuron state calculated through the calculation unit; and
a switch configured to select an input of the second memory.

54. The neural network computing apparatus of claim 46, wherein the calculation unit comprises:
a multiplication unit configured to perform a multiplication on the connection weights and the forward neuron states or the connection weights and the backward neuron error values from the respective memory units;
an addition unit having a tree structure and configured to perform an addition on a plurality of output values from the multiplication unit through one or more stages;
an accumulator configured to accumulate output values from the addition unit; and
a soma processor configured to receive training data from the control unit and the accumulated output value from the accumulator, and calculate a new forward neuron state or backward neuron error value.

55-60. (canceled)

61. A memory device of a digital system, wherein a double memory swap circuit which swaps and connects all inputs and outputs of two memories using a plurality of digital switches controlled by a control signal from an external control unit is applied to the two memories.

62. A neural network computing method comprising:
outputting, by a plurality of memory units, connection weights and neuron states, respectively, according to control of a control unit; and
calculating, by a calculation unit, a new neuron state using the connection weight and the neuron state which are inputted from each of the memory units and feeding back the new neuron state to each of the memory units, according to control of the control unit,
wherein the plurality of memory units and the calculation unit are synchronized with one system clock and operated in a pipeline manner according to control of the control unit.

63. A neural network computing method comprising:
receiving data, which is to be provided to an input neuron, from a control unit according to control of the control unit;
switching the received data or a new neuron state from a calculation unit to a plurality of memory units according to control of the control unit;
outputting, by the plurality of memory units, connection weights and neuron states, respectively, according to control of the control unit;
calculating, by the calculation unit, a new neuron state using the connection weight and the neuron state which are inputted from each of the memory units, according to control of the control unit; and
outputting, by first and second output units, the new neuron state from the calculation unit to the control unit, wherein the first and second output units are implemented with a double memory swap circuit which swaps and connects all inputs and outputs according to control of the control unit.

64. A neural network computing method comprising:
outputting, by a plurality of memory parts within a plurality of memory units, connection weights and neuron states, respectively, according to control of a control units; and
calculating, by a plurality of calculation units, new neuron states using the connection weights and the neuron states which are inputted from the corresponding memory parts within the plurality of memory units and feeding back the new neuron states to the corresponding memory parts, according to control of the control unit,
wherein the plurality of memory parts within the plurality of memory units and the plurality of calculation units are synchronized with one system clock and operated in a pipeline manner according to control of the control unit.

65. A neural network computing method comprising:
outputting, by a plurality of memory units, connection weights and neuron error values, respectively, according to control of a control unit; and
calculating, by a calculation unit, a new neuron error value using the connection weight and the neuron error value which are inputted from each of the memory units and feeding back the new neuron error value to each of the memory units, according to control of the control unit,
wherein the plurality of memory units and the calculation unit are synchronized with one system clock and operated in a pipeline manner according to control of the control unit.

66. A neural network computing method comprising:
outputting, by a plurality of memory units, connection weights and neuron state, respectively, according to control of a control unit;
calculating, by a calculation unit, a new neuron state and a learning attribute using the connection weight and the neuron state which are inputted from each of the memory units, according to control of the control units; and
calculating, by the plurality of memory units, new connection weights using the connection weights, the neuron states, and the learning attribute, according to control of the control unit,
wherein the plurality of memory units and the calculation unit are synchronized with one system clock and operated in a pipeline manner according to control of the control unit.

67. A neural network computing method comprising:
storing and outputting, by a plurality of memory units, connection weight, forward neuron states, and backward neuron error values, respectively, and calculating new connection weight, according to control of a control unit; and
calculating, by a calculation unit, a new forward neuron state and a new backward neuron error value based on data inputted from each of the memory units and feeding back the new forward neuron state and the new backward neuron error value to each of the memory units, according to control of the control unit,
wherein the plurality of memory units and the calculation unit are synchronized with one system clock and operated in a pipeline manner according to control of the control unit.

68. (canceled)
